(19) United States
(12) Patent Application Publication
(10) Pub. No.: US 2026/0238314 A1
(43) Pub. Date: Aug. 13, 2026

(54) METHOD AND APPARATUS FOR BEAM FAILURE RECOVERY OPERATION CONSIDERING DRX ACTIVE TIME

(71) Applicant: LG ELECTRONICS INC., Seoul (KR)

(72) Inventors: Giwon PARK, Seoul (KR); Seoyoung BACK, Seoul (KR); Seungmin LEE, Seoul (KR)

(21) Appl. No.: 19/153,572

(22) PCT Filed: Feb. 2, 2024
(86) PCT No.: PCT/KR2024/001600

§ 371 Date: Aug. 4, 2025

Related U.S. Application Data
(60) Provisional application No. 63/443,962, filed on Feb. 7, 2023.
(60) Provisional application No. 63/445,677, filed on Feb. 14, 2023.
(60) Provisional application No. 63/445,969, filed on Feb. 15, 2023.

(30) Foreign Application Priority Data
Feb. 16, 2023 (KR) 10-2023-0020777

(51) Int. Cl. H04B 7/06; H04W 76/28

(52) U.S. Cl. CPC H04B 7/06964; H04W 76/28

(57) ABSTRACT

Provided are a method by which a first device performs wireless communication and an apparatus supporting same. The method may comprise the steps of: acquiring configuration information related to discontinuous reception (DRX); triggering a beam failure recovery (BRF); on the basis of the triggered BFR, transmitting a BFR medium access control (MAC) control element (CE) to a second device; and receiving, from the second device, an MAC CE including information related to whether or not the BFR is successful. For example, a time duration between the transmission of the BFR MAC CE and the reception of the MAC CE including the information related to whether or not the BFR is successful may be an active time of the first device.

### CROSS-REFERENCE TO RELATED APPLICATIONS

This application is the National Stage filing under 35 U.S.C. 371 of International Application No. PCT/KR2024/001600 filed on Feb. 2, 2024, which claims the benefit of U.S. Patent Application No. 63/443,962 filed on Feb. 7, 2023, U.S. Patent Application No. 63/445,677 filed on Feb. 14, 2023, U.S. Patent Application No. 63/445,969 filed on Feb. 15, 2023, and Korean Patent Application No. 10-2023-0020777 filed on Feb. 16, 2023, which is hereby incorporated by reference herein in its entirety.

### TECHNICAL FIELD

This disclosure relates to a wireless communication system.

### BACKGROUND

5G NR is a successive technology of long term evolution (LTE) corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

The 6G (wireless communication) system is aimed at (i) very high data rates per device, (ii) a very large number of connected devices, (iii) global connectivity, (iv) very low latency, (v) lower energy consumption for battery-free IoT devices, (vi) ultra-reliable connectivity, and (vii) connected intelligence with machine learning capabilities. The vision of the 6G system can have four aspects: intelligent connectivity, deep connectivity, holographic connectivity, and ubiquitous connectivity, and the 6G system can satisfy the requirements as shown in Table 1 below. In other words, Table 1 is an example of the requirements of a 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

### SUMMARY

In one embodiment, provided is a method for performing wireless communication by a first device. The method may comprise: obtaining configuration information related to a discontinuous reception (DRX); triggering a beam failure recovery (BFR); transmitting, to a second device, a BFR medium access control (MAC) control element (CE), based on the triggered BFR; and receiving, from the second device, a MAC CE including information related to whether the BFR has succeeded. For example, a time duration between the transmission of the BFR MAC CE and the reception of the MAC CE including information related to whether the BFR has succeeded may be an active time of the first device.

In one embodiment, provided is a first device configured to perform wireless communication. The first device may comprise: at least one transceiver; at least one processor; and at least one memory connected to the at least one processor and storing instructions. For example, the instructions, based on being executed by the at least one processor, cause the first device to perform operations comprising: obtaining configuration information related to a discontinuous reception (DRX); triggering a beam failure recovery (BFR); transmitting, to a second device, a BFR medium access control (MAC) control element (CE), based on the triggered BFR; and receiving, from the second device, a MAC CE including information related to whether the BFR has succeeded. For example, a time duration between the transmission of the BFR MAC CE and the reception of the MAC CE including information related to whether the BFR has succeeded may be an active time of the first device.

In one embodiment, provided is a processing device configured to control a first device. The processing device may comprise: at least one processor; and at least one memory connected to the at least one processor and storing instructions. For example, the instructions, based on being executed by the at least one processor, cause the first device to perform operations comprising: obtaining configuration information related to a discontinuous reception (DRX); triggering a beam failure recovery (BFR); transmitting, to a second device, a BFR medium access control (MAC) control element (CE), based on the triggered BFR; and receiving, from the second device, a MAC CE including information related to whether the BFR has succeeded. For example, a time duration between the transmission of the BFR MAC CE and the reception of the MAC CE including information related to whether the BFR has succeeded may be an active time of the first device.

In one embodiment, provided is a non-transitory computer-readable storage medium recording instructions. For example, the instructions, based on being executed, cause a first device to perform operations comprising: obtaining configuration information related to a discontinuous reception (DRX); triggering a beam failure recovery (BFR); transmitting, to a second device, a BFR medium access control (MAC) control element (CE), based on the triggered BFR; and receiving, from the second device, a MAC CE including information related to whether the BFR has succeeded. For example, a time duration between the transmission of the BFR MAC CE and the reception of the MAC CE including information related to whether the BFR has succeeded may be an active time of the first device.

### BRIEF DESCRIPTION OF THE DRAWINGS

FIG. 1 shows a communication structure that can be provided in the 6G system, based on an embodiment of the present disclosure.

FIG. 2 shows an electromagnetic spectrum, based on an embodiment of the present disclosure.

FIG. 3 shows an example of an NTN typical scenario based on a transparent payload, based on an embodiment of the present disclosure.

FIG. 4 shows an example of an NTN typical scenario based on a regenerative payload, based on an embodiment of the present disclosure.

FIG. 5 shows an example of a sensing operation, based on an embodiment of the present disclosure.

FIG. 6 shows a structure of a slot of a frame, based on an embodiment of the present disclosure.

FIG. 7 shows an example of a BWP, based on an embodiment of the present disclosure.

FIG. 8 shows a procedure of performing V2X or SL communication by a UE based on a transmission mode, based on an embodiment of the present disclosure.

FIG. 9 shows a beam failure recovery (BFR) operation, based on an embodiment of the present disclosure.

FIG. 10 shows a beam failure recovery (BFR) operation considering DRX active time, based on an embodiment of the present disclosure.

FIG. 11 shows a beam failure recovery (BFR) operation considering DRX active time, based on an embodiment of the present disclosure.

FIG. 12 shows a method for performing wireless communication by a first device, based on an embodiment of the present disclosure.

FIG. 13 shows a method for performing wireless communication by a second device, based on an embodiment of the present disclosure.

FIG. 14 shows a communication system 1, based on an embodiment of the present disclosure.

FIG. 15 shows wireless devices, based on an embodiment of the present disclosure.

FIG. 16 shows a signal process circuit for a transmission signal, based on an embodiment of the present disclosure.

FIG. 17 shows another example of a wireless device, based on an embodiment of the present disclosure.

FIG. 18 shows a hand-held device, based on an embodiment of the present disclosure.

FIG. 19 shows a vehicle or an autonomous vehicle, based on an embodiment of the present disclosure.

### DETAILED DESCRIPTION

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

In the following description, ‘when, if, or in case of’ may be replaced with ‘based on’.

A technical feature described individually in one figure in the present disclosure may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

In the present disclosure, “configured or defined” may be interpreted as being configured or pre-configured to a device through pre-defined signaling (e.g., SIB, MAC, RRC) from a base station or network. In the present disclosure, “configured or defined” may be interpreted as being pre-configured to a device.

The technology proposed in the present disclosure may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), long term evolution (LTE), 5G NR, and so on.

The technology proposed in the present disclosure may be implemented as 6G wireless technology and may be applied to various 6G systems. For example, 6G systems may have key factors such as enhanced mobile broadband (eMBB), ultra-reliable low latency communications (URLLC), massive machine-type communication (mMTC), artificial intelligence (AI) unified communications, tactile internet, high throughput, high network capacity, high energy efficiency, low backhaul and access network congestion, and enhanced data security.

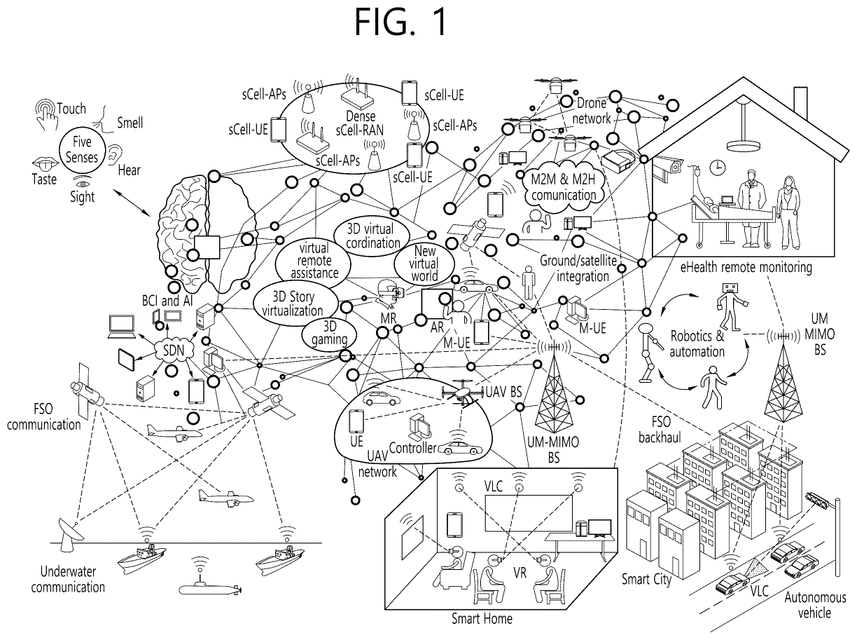

FIG. 1 shows a communication structure that can be provided in the 6G system, based on an embodiment of the present disclosure. The embodiment of FIG. 1 may be combined with various embodiments of the present disclosure.

New network characteristics in 6G may include:
Satellites integrated network
Connected intelligence: Unlike previous generations of wireless communication systems, 6G is revolutionary and the wireless evolution will be updated from “connected things” to “connected intelligence”. AI can be applied at each step of the communication procedure (or each procedure of signal processing, which will be described below).
Seamless integration wireless information and energy transfer
Ubiquitous super 3D connectivity: Access to drones, networks for very low Earth orbit satellites and core network functions will create super 3D connectivity in 6G ubiquitous.

In the above new network characteristics of 6G, some general requirements may be as follows.
Small cell networks
Ultra-dense heterogeneous network
High-capacity backhaul
Radar technology integrated with mobile technology: High-precision localization (or location-based services) through communication is one of the functions of the 6G wireless communication system. Therefore, radar systems will be integrated with 6G networks.
Softwarization and virtualization

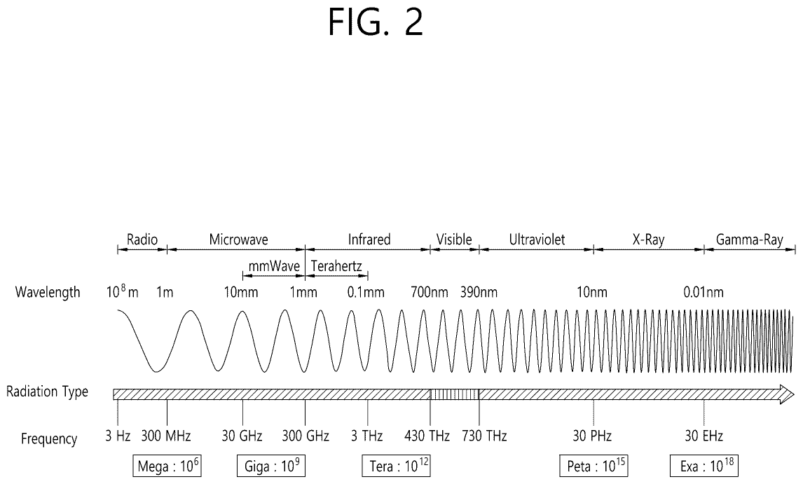

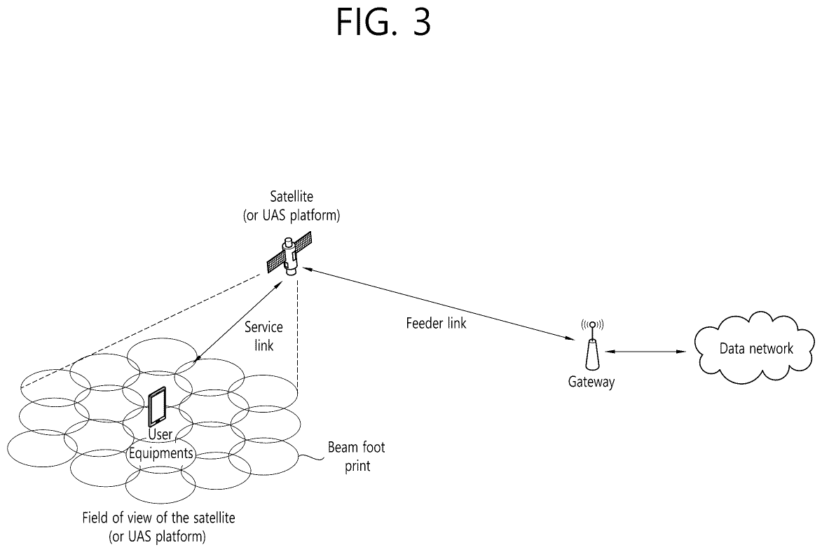

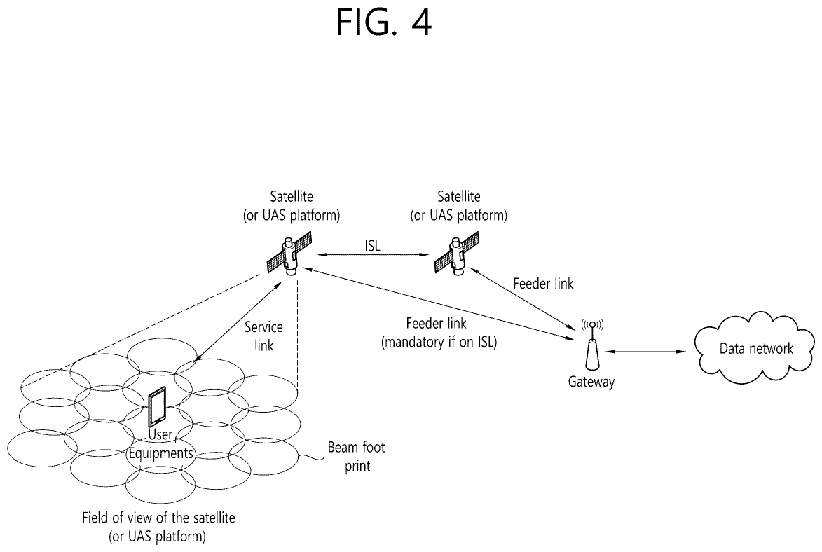

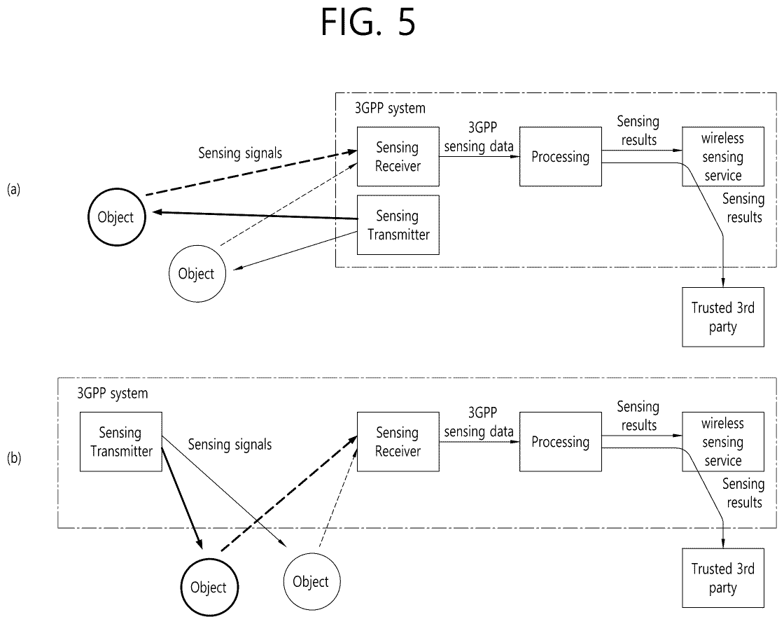

The following describes the key enabling technologies for 6G systems.
Artificial Intelligence: The introduction of AI in telecommunications can streamline and improve real-time data transfer. AI can use numerous analytics to determine how complex target tasks are performed, meaning AI can increase efficiency and reduce processing delays. Time-consuming tasks such as handover, network selection, and resource scheduling can be done instantly by using AI. AI can also play an important role in M2M, machine-to-human, and human-to-machine communications. In addition, AI can be a rapid communication in Brain Computer Interface (BCI). AI-based communication systems can be supported by metamaterials, intelligent structures, intelligent networks, intelligent devices, intelligent cognitive radios, self-sustaining wireless networks, and machine learning.
THz Communication (terahertz communication): Data rates can be increased by increasing bandwidth. This can be accomplished by using sub-THz communication with a wide bandwidth and applying advanced massive MIMO technology. THz waves, also known as submillimeter radiation, refer to frequency bands between 0.1 and 10 THz with corresponding wavelengths typically ranging from 0.03 mm-3 mm. The 100 GHz-300 GHz band range (Sub THz band) is considered the main part of the THz band for cellular communications. Adding the Sub-THz band to the mmWave band increases the capacity of 6G cellular communications. Of the defined THz band, 300 GHz-3 THz is in the far infrared (IR) frequency band. The 300 GHz-3 THz band is part of the optical band, but it is on the border of the optical band, just behind the RF band. Thus, the 300 GHz-3 THz band exhibits similarities to RF. FIG. 2 illustrates an electromagnetic spectrum, according to one embodiment of the present disclosure. The embodiment of FIG. 2 may be combined with various embodiments of the present disclosure. Key characteristics of THz communications include (i) widely available bandwidth to support very high data rates, and (ii) high path loss at high frequencies, for which highly directive antennas are indispensable. The narrow beamwidth produced by highly directive antennas reduces interference. The small wavelength of THz signals allows a much larger number of antenna elements to be integrated into devices and BSs operating in this band. This enables the use of advanced adaptive array techniques that can overcome range limitations.
Large-scale MIMO Technology (Large-scale MIMO)
Hologram Beamforming (HBF, Hologram Beamforming)
Optical wireless technology
Free-space optical transmission backhaul network (FSO Backhaul Network)
Quantum Communication
Cell-free Communication
Integration of Wireless Information and Power Transmission
Integration of Wireless Communication and Sensing
Integrated Access and Backhaul Network
Big data Analysis
Reconfigurable Intelligent Surface
Metaverse
Block-chain
Unmanned aerial vehicles (UAVs): UAVs or drones will be an important component of 6G wireless communications. In most cases, high-speed data wireless connectivity may be provided using UAV technology. Base Station (BS) entities may be installed on UAVs to provide cellular connectivity. UAVs may have certain features not found in fixed BS infrastructure, such as easy deployment, strong line-of-sight links, and controlled degrees of freedom for mobility. During emergencies, such as natural disasters, the deployment of terrestrial telecom infrastructure is not economically feasible and sometimes cannot provide services in volatile environments. UAVs can easily handle these situations. UAVs will be a new paradigm in wireless communications. This technology facilitates the three basic requirements of wireless networks, which are eMBB, URLLC, and mMTC. UAVs can also support many other purposes such as enhancing network connectivity, fire detection, disaster emergency services, security and surveillance, pollution monitoring, parking monitoring, accident monitoring, etc. Therefore, UAV technology is recognized as one of the most important technologies for 6G communications.
Advanced air mobility (AAM): AAM is the parent concept of urban air mobility (UAM), which is a means of air transportation that can be used in urban centers, and can refer to a means of transportation that includes movement between urban centers and regional bases.
Autonomous Driving (autonomous driving, self-driving): Vehicle to Everything (V2X), a key element in building an autonomous driving infrastructure, can be a technology that enables vehicles to communicate and share information with various elements on the road, such as vehicle-to-vehicle (V2V) and vehicle-to-infrastructure (V2I) wireless communication, in order to perform autonomous driving. In order to maximize the performance of autonomous driving and ensure high safety, fast transmission speeds and low latency technologies are essential. In addition, in the future, autonomous driving may need to go beyond delivering warnings or guidance messages to the driver and actively intervene in vehicle operation, requiring direct control of the vehicle in dangerous situations. To do this, the amount of information that needs to be transmitted and received can be massive, so 6G is expected to maximize autonomous driving with faster transmission speeds and lower latency than 5G.
Non-terrestrial networks (NTN): An NTN may represent a network or network segment that uses radio frequency (RF) resources mounted on a satellite (or unmanned aerial system (UAS) platform). FIG. 3 shows an example of an NTN typical scenario based on a transparent payload, based on an embodiment of the present disclosure. FIG. 4 shows an example of an NTN typical scenario based on a regenerative payload, based on an embodiment of the present disclosure. The embodiment of FIG. 3 or FIG. 4 may be combined with various embodiments of the present disclosure. Referring to FIG. 3, a satellite (or UAS platform) may establish a service link with a UE. The satellite (or UAS platform) may be connected to the gateway via a feeder link. The satellite may be connected to the data network via the gateway. A beam footprint may refer to an area that can receive signals transmitted by a satellite. Referring to FIG. 4, a satellite (or UAS platform) may create a service link with a UE. A satellite (or UAS platform) connected to a UE may be connected to other satellites (or UAS platforms) via inter-satellite links (ISL). Other satellites (or UAS platforms) can be connected to the gateway via feeder links. Satellites may be connected to data networks via other satellites and gateways, based on the regenerative payload. If an ISL does not exist between a satellite and another satellite, a feeder link between the satellite and the gateway may be required. FIG. 3 and FIG. 4 are only examples of NTN scenarios, and NTN can be implemented based on various types of scenarios. For example, a satellite (or UAS platform) may implement a transparent or regenerative (with on-board processing) payload. For example, a satellite (or UAS platform) may generate multiple beams over a designated service area based on the field of view of the satellite (or UAS platform). For example, the field of view of the satellite (or UAS platform) may be different based on the on-board antenna diagram and the minimum elevation angle. For example, transparent payloads may include radio frequency filtering, frequency conversion, and amplification. Accordingly, the waveform signal repeated by the payload may not be changed. For example, a regenerative payload may include radio frequency filtering, frequency conversion and amplification, demodulation/decryption, switching and/or routing, and coding/modulation. For example, a regenerative payload may be substantially equivalent to equipping a satellite (or UAS platform) with all or part of the base station functionality.
Integrated sensing and communication (ISAC): Wireless sensing is a technology that obtains information about the environment and/or the characteristics of objects within the environment by using radio frequencies to determine the instantaneous linear speed, angle, and distance (range) of the object. Since the radio frequency sensing function does not require connection to the object through a device in the network, it can provide a service for determining the location of the object without a device. The function to obtain range, speed, and angle information from radio frequency signals can provide a wide range of new capabilities, such as detection of various objects, object recognition (e.g., vehicles, humans, animals, UAVs), and high-precision positioning, tracking, and activity recognition. Wireless sensing services can provide information to various industries (e.g., unmanned aerial vehicles, smart homes, V2X, factories, railroads, public safety, etc.), enabling applications that provide, for example, intruder detection, assisted vehicle control and navigation, trajectory tracking, collision avoidance, traffic management, health and traffic management, etc. In some cases, wireless sensing may use non-3GPP type sensors (e.g., radar, cameras) to further support 3GPP-based sensing. For example, the operation of a wireless sensing service, that is, the sensing operation, may depend on the processing of transmission, reflection, and scattering of wireless sensing signals. Therefore, wireless sensing may provide an opportunity to enhance existing communication systems from communication networks to wireless communication and sensing networks. FIG. 5 shows an example of a sensing operation, based on an embodiment of the present disclosure. The embodiment of FIG. 5 may be combined with various embodiments of the present disclosure. Specifically, (a) of FIG. 5 illustrates an example of sensing using a sensing receiver and a sensing transmitter at the same location (e.g., monostatic sensing), and (b) of FIG. 5 illustrates an example of sensing using separate sensing receivers and sensing transmitters (e.g., bistatic sensing).

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

The physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., a MAC layer, an RLC layer, a packet data convergence protocol (PDCP) layer, and a service data adaptation protocol (SDAP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

A radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined based on subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 2 shown below represents an example of a number of symbols per slot (N^{slot}_{symb}), a number slots per frame (N^{frame,u}ₛₗₒₜ), and a number of slots per subframe (N^{subframe,u}ₛₗₒₜ) based on an SCS configuration (u), in a case where a normal CP or extended CP is used.

TABLE 2

| CP type | SCS (15*2^{u}) | N^{slot}_{symb} | N^{frame, u}ₛₗₒₜ | N^{subframe, u}ₛₗₒₜ |
|---|---|---|---|---|
| normal CP | 15 kHz (u = 0) | 14 | 10 | 1 |
| | 30 kHz (u = 1) | 14 | 20 | 2 |
| | 60 kHz (u = 2) | 14 | 40 | 4 |
| | 120 kHz (u = 3) | 14 | 80 | 8 |
| | 240 kHz (u = 4) | 14 | 160 | 16 |
| extended CP | 60 kHz (u = 2) | 12 | 40 | 4 |

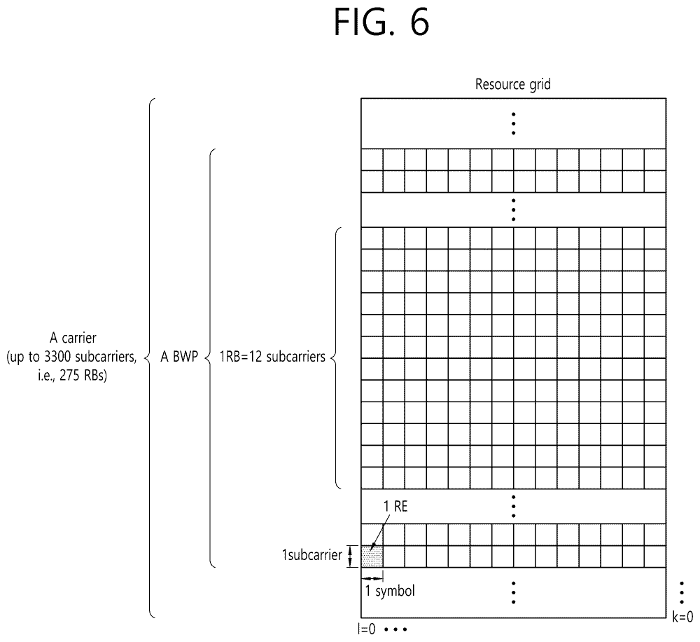

FIG. 6 shows a structure of a slot of a frame, based on an embodiment of the present disclosure. The embodiment of FIG. 6 may be combined with various embodiments of the present disclosure.

Referring to FIG. 6, a slot includes a plurality of symbols in a time domain. A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

The BWP may be a set of consecutive physical resource blocks (PRBs) in a given numerology. The PRB may be selected from consecutive sub-sets of common resource blocks (CRBs) for the given numerology on a given carrier.

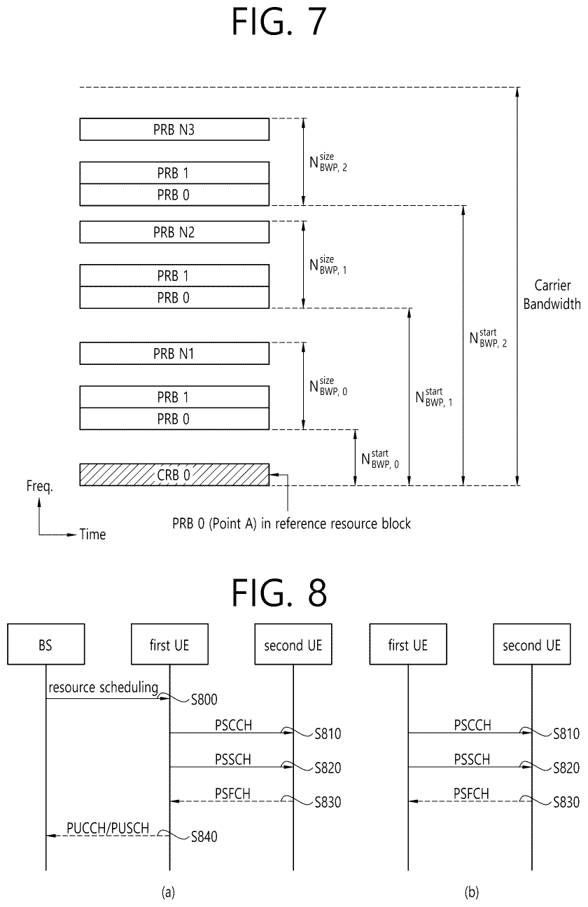

FIG. 7 shows an example of a BWP, based on an embodiment of the present disclosure. The embodiment of FIG. 7 may be combined with various embodiments of the present disclosure. It is assumed in the embodiment of FIG. 7 that the number of BWPs is 3.

Referring to FIG. 7, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

A sidelink synchronization signal (SLSS) may include a primary sidelink synchronization signal (PSSS) and a secondary sidelink synchronization signal (SSSS), as a sidelink (SL)-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit cyclic redundancy check (CRC).

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

In the present disclosure, PSCCH may be replaced with a control channel, a physical control channel, a control channel related to the sidelink, a physical control channel related to the sidelink, etc. In the present disclosure, PSSCH may be replaced with a shared channel, a physical shared channel, a shared channel related to a sidelink, a physical shared channel related to a sidelink, etc.

FIG. 8 shows a procedure of performing V2X or SL communication by a UE based on a resource allocation mode, based on an embodiment of the present disclosure. The embodiment of FIG. 8 may be combined with various embodiments of the present disclosure.

Referring to (a) of FIG. 8, in the resource allocation mode 1, a base station may schedule SL resource(s) to be used by a UE for SL transmission. For example, in step S800, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

In step S810, the first UE may transmit a PSCCH (e.g., sidelink control information (SCI) or 1st-stage SCI) to a second UE based on the resource scheduling. In step S820, the first UE may transmit a PSSCH (e.g., 2nd-stage SCI, MAC PDU, data, etc.) related to the PSCCH to the second UE. In step S830, the first UE may receive a PSFCH related to the PSCCH/PSSCH from the second UE. For example, HARQ feedback information (e.g., NACK information or ACK information) may be received from the second UE through the PSFCH. In step S840, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling.

Referring to (b) of FIG. 8, in the resource allocation mode 2, a UE may determine SL transmission resource(s) within SL resource(s) configured by a base station/network or pre-configured SL resource(s). For example, the configured SL resource(s) or the pre-configured SL resource(s) may be a resource pool. For example, the UE may autonomously select or schedule resource(s) for SL transmission. For example, the UE may perform SL communication by autonomously selecting resource(s) within the configured resource pool. For example, the UE may autonomously select resource(s) within a selection window by performing a sensing procedure and a resource (re)selection procedure. For example, the sensing may be performed in a unit of subchannel(s). For example, in step S810, a first UE which has selected resource(s) from a resource pool by itself may transmit a PSCCH (e.g., sidelink control information (SCI) or 1st-stage SCI) to a second UE by using the resource(s). In step S820, the first UE may transmit a PSSCH (e.g., 2nd-stage SCI, MAC PDU, data, etc.) related to the PSCCH to the second UE. In step S830, the first UE may receive a PSFCH related to the PSCCH/PSSCH from the second UE.

Referring to (a) or (b) of FIG. 8, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1st SCI, a first SCI, a 1st-stage SCI or a 1st-stage SCI format, and a SCI transmitted through a PSSCH may be referred to as a 2nd SCI, a second SCI, a 2nd-stage SCI or a 2nd-stage SCI format.

Referring to (a) or (b) of FIG. 8, in step S830, the first UE may receive the PSFCH. For example, the first UE and the second UE may determine a PSFCH resource, and the second UE may transmit HARQ feedback to the first UE using the PSFCH resource.

Referring to (a) of FIG. 8, in step S840, the first UE may transmit SL HARQ feedback to the base station through the PUCCH and/or the PUSCH.

In various embodiments of the present disclosure, a TX UE and/or an RX UE may obtain a discontinuous reception (DRX) configuration. For example, the DRX configuration may include a Uu DRX configuration and/or a SL DRX configuration. For example, the TX UE may receive the DRX configuration from a base station, and the RX UE may receive the DRX configuration from the TX UE. For example, the DRX configuration may be configured or pre-configured for the TX UE and/or the RX UE.

For example, the Uu DRX configuration may include information related to drx-HARQ-RTT-Timer-SL and/or information related to drx-RetransmissionTimer-SL. For example, the timer may be used for the following purposes.

(1) drx-HARQ-RTT-Timer-SL (per HARQ process): drx-HARQ-RTT-Timer-SL may be the minimum duration before a sidelink HARQ retransmission grant is expected by the MAC entity. drx-HARQ-RTT-Timer-SL may refer to the minimum time required until a resource for SL mode 1 retransmission is prepared. That is, the resource for sidelink retransmission cannot be prepared before the drx-HARQ-RTT-Timer-SL timer. Accordingly, the TX UE can reduce power consumption by transitioning to a sleep mode during the drx-HARQ-RTT-Time-SL timer. Or, the TX UE may not perform mode 1 DCI monitoring from the base station. If the drx-HARQ-RTT-Timer-SL timer expires, the TX UE may determine that a resource for SL retransmission may be prepared. Accordingly, the TX UE may start the drx-RetransmissionTimer-SL timer and monitor whether resource(s) for SL HARQ retransmission is received. As soon as the drx-HARQ-RTT-Timer-SL timer expires, the SL HARQ retransmission resource(s) may or may not be received, so the TX UE may start the drx-RetransmissionTimer-SL timer, and the TX UE may monitor mode 1 DCI from the base station to receive resource(s) for SL HARQ retransmission. For example, the drx-HARQ-RTT-Timer-SL timer may be a duration in which the TX UE performing sidelink communication based on sidelink resource allocation mode 1 (e.g., the UE supporting Uu DRX operation) does not perform PDCCH (or DCI) monitoring for sidelink mode 1 resource allocation from the base station.

(2) drx-RetransmissionTimer-SL (per HARQ process): drx-RetransmissionTimer-SL may be the maximum duration until a grant for sidelink retransmission is received. That is, the drx-RetransmissionTimer-SL timer may be a timer started when the drx-HARQ-RTT-Timer-SL timer expires, and it may be a timer that allows the TX UE to transition to an active state for SL retransmission. Or, while the corresponding timer is running, the TX UE may monitor mode 1 DCI from the base station. The TX UE may start monitoring SL mode 1 DCI from the base station, in order to check whether retransmission resource(s) (i.e., grant for sidelink retransmission) to the RX UE is prepared, from a time when drx-RetransmissionTimer-SL starts. And, if retransmission resource(s) is prepared, the TX UE may perform sidelink HARQ retransmission to the RX UE. When transmitting a HARQ retransmission packet to the RX UE, the TX UE may stop the drx-RetransmissionTimer-SL timer. While the drx-RetransmissionTimer-SL timer is running, the UE may maintain an active state. For example, the drx-RetransmissionTimer-SL timer may be a duration in which the TX UE performing sidelink communication based on sidelink resource allocation mode 1 (e.g., the UE supporting Uu DRX operation) performs PDCCH (or DCI) monitoring for sidelink mode 1 resource allocation from the base station.

For example, the SL DRX configuration may include at least one parameter/information among parameters/information described below.

(1) SL drx-onDurationTimer: the duration at the beginning of a SL DRX Cycle

(2) SL drx-SlotOffset: the delay before starting the sl drx-onDurationTimer

(3) SL drx-InactivityTimer: the duration after the PSCCH occasion in which a PSCCH indicates a new SL transmission for the MAC entity

(4) SL drx-RetransmissionTimer (per HARQ process or per sidelink process): the maximum duration until a retransmission is received

(5) SL drx-HARQ-RTT-Timer (per HARQ process or per sidelink process): the minimum duration before PSCCH (Sidelink Control Information) & PSSCH for SL HARQ retransmission is expected by the MAC entity

(6) SL drx-LongCycleStartOffset: the Long DRX cycle and drx-StartOffset which defines the subframe where the Long and Short DRX Cycle starts

(7) SL drx-ShortCycle (optional): the Short DRX cycle

(8) SL drx-ShortCycleTimer (optional): the duration the UE shall follow the Short DRX cycle

(9) SL drx-HARQ-RTT-Timer (per sidelink process): the minimum duration before an assignment for HARQ retransmission is expected by the MAC entity

(10) SL drx-StartOffset: the subframe where the SL DRX cycle start

(11) SL drx-Cycle: SL DRX cycle

The SL DRX timer described in the present disclosure may be used for the following purposes.

(1) SL DRX onduration timer: the duration in which the UE performing the SL DRX operation should basically operate in an active time in order to receive a PSCCH/PSSCH from other UE(s)

(2) SL DRX inactivity timer: the duration extending the SL DRX onduration duration, which is the duration in which the UE performing the SL DRX operation should basically operate in the active time in order to receive the PSCCH/PSSCH from other UE(s)

For example, the UE may extend the SL DRX onduration timer by the SL DRX inactivity timer duration. In addition, if the UE receives a new packet (e.g., new PSSCH transmission) from other UE(s), the UE may extend the SL DRX onduration timer by starting the SL DRX inactivity timer.

For example, the SL DRX inactivity timer may be used for extending the SL DRX onduration duration, which is the duration in which the RX UE performing the SL DRX operation should basically operate in the active time in order to receive the PSCCH/PSSCH from other UE(s). That is, the SL DRX onduration timer may be extended by the SL DRX inactivity timer period. In addition, if the RX UE receives a new packet (e.g., new PSSCH transmission) from other TX UE(s), the RX UE may extend the SL DRX onduration timer by starting the SL DRX inactivity timer.

(3) SL DRX HARQ RTT timer: the duration in which the UE performing the SL DRX operation operates in a sleep mode until receiving a retransmission packet (or PSSCH assignment) transmitted by other UE(s)

For example, if the UE starts the SL DRX HARQ RTT timer, the UE may determine that other UE(s) will not transmit a sidelink retransmission packet to the UE until the SL DRX HARQ RTT timer expires, and the UE may operate in a sleep mode while the corresponding timer is running. For example, if the UE starts the SL DRX HARQ RTT timer, the UE may not monitor a sidelink retransmission packet from other UE(s) until the SL DRX HARQ RTT timer expires. For example, if the RX UE which has received a PSCCH/PSSCH transmitted by the TX UE transmits SL HARQ NACK feedback, the RX UE may start the SL DRX HARQ RTT timer. In this case, the RX UE may determine that other TX UE(s) will not transmit a sidelink retransmission packet to the RX UE until the SL DRX HARQ RTT timer expires, and the RX UE may operate in a sleep mode while the corresponding timer is running.

(4) SL DRX retransmission timer: the timer which starts when the SL DRX HARQ RTT timer expires, and the duration in which the UE performing the SL DRX operation operates in an active time in order to receive a retransmission packet (or PSSCH assignment) transmitted by other UE(s)

For example, for the corresponding timer duration, the UE may receive or monitor a retransmission sidelink packet (or PSSCH assignment) transmitted by other UE(s). For example, the RX UE may receive or monitor a retransmission sidelink packet (or PSSCH assignment) transmitted by other TX UE(s) while the SL DRX retransmission timer is running.

The Uu DRX timers mentioned in the present disclosure may be used for the following purposes.

(1) drx-HARQ-RTT-TimerSL timer: a duration in which a transmitting UE (e.g., a UE supporting Uu DRX operation) performing sidelink communication based on sidelink resource allocation mode 1 does not monitor the PDCCH (or DCI) from the base station for sidelink mode 1 resource allocation.

(2) drx-RetransmissionTimerSL timer: a duration in which a transmitting UE (e.g., a UE supporting Uu DRX operation) performing sidelink communication based on sidelink resource allocation mode 1 does monitor the PDCCH (or DCI) from the base station for sidelink mode 1 resource allocation.

In the present disclosure, the names of the timers (e.g., Sidelink DRX Onduration Timer, Sidelink DRX Inactivity Timer, Sidelink DRX HARQ RTT Timer, Sidelink DRX Retransmission Timer, drx-HARQ-RTT-Timer-SL, or drx-RetransmissionTimer-SL) are exemplary, and timers that perform the same or similar functions as described may be regarded as identical or similar timers regardless of their names.

A UE operating in sidelink DRX may operate in active mode during DRX active time (e.g., onduration timer, inactivity timer, retransmission timer, or duration when operating in active mode) to perform PSCCH/PSSCH monitoring. However, the UE may operate in sleep mode during the sidelink DRX inactive time duration and not perform PSCCH/PSSCH monitoring operations for SL data reception.

In sidelink unicast, a UE may negotiate/determine the sidelink DRX configuration (SL DRX configuration to be used during sidelink unicast communication) with the other UE with which it has established a unicast connection. If there is a connection (RRC connection) between the transmission UE and the base station, the base station of the transmission UE may configure the SL DRX configuration to be used by the reception UE that has established a unicast connection with the transmission UE and inform the transmission UE, and the transmission UE may transmit the SL DRX configuration to be used by the reception UE received from the base station to the reception UE through a PC5 RRC message. If there is no connection (RRC connection) between the transmission UE and the base station, the transmission UE may configure the SL DRX configuration to be used by the reception UE that has established a unicast connection with the transmission UE directly and transmit it to the reception UE through a PC5 RRC message.

While SL DRX is an operation for the reception UE, the transmission UE also needs to know the SL DRX operation status of the reception UE (active or sleep mode, or when the DRX onduration/inactivity/HARQ RTT/retransmission timer starts, when the DRX onduration/inactivity/HARQ RTT/retransmission timer expires, etc). For example, when allocating and transferring resources, the transmission UE should be able to determine whether the reception UE is operating in active mode or sleep mode. Therefore, the transmission UE may apply the same SL DRX configuration as the reception UE to maintain the same operation state of the SL DRX timer, etc. as the reception UE.

The AS layer of a UE (RX UE or TX UE) supporting SL DRX behavior may receive a Tx profile mapped for an available sidelink service from a higher layer (e.g., V2X layer). The Tx profile may include information distinguishing whether an available sidelink service or an interested sidelink service is a sidelink service that needs to perform SL DRX operation. Therefore, when the AS layer of a UE receives the available sidelink data (or the interested sidelink service) and Tx profile from the upper layer, the UE may decide (or determine) that it should or should not support SL DRX operation for the available sidelink data (or the interested sidelink service).

Meanwhile, in conventional NR Uu (e.g., operations between a base station and a UE), beam management operations (e.g., beam scheduling, beam selection, beam failure recovery) in mmWave frequencies have been newly introduced. For example, the UE may perform SL FR2 (sidelink communication based on sidelink mmWave frequencies) operations based on the following operations.

Additionally, for example, a sidelink UE supporting DRX operation may operate in a sleep mode during a non-DRX active time in order to reduce power consumption (e.g., a receiving UE may not perform PSCCH/PSSCH monitoring for data reception while operating in sleep mode during the non-DRX active time). Additionally, for example, a receiving UE supporting DRX operation may monitor PSCCH/PSSCH transmitted by the transmitting UE during its DRX active time. For example, a transmitting UE supporting DRX operation may transmit PSCCH/PSSCH during DRX active time of the receiving UE so that the receiving UE may reliably receive the transmitted PSCCH/PSSCH.

In the present disclosure, the DRX active time operation of a UE performing DRX operation in SL FR2 is proposed as follows.

For example, a UE performing DRX operation in SL FR2 may perform the following beam management operations (e.g., beam sweeping, beam pairing, beam failure recovery, beam/reference signal (RS) measurement, beam scheduling, beam selection, etc.).
Beam sweeping operation: an operation in which the UE covers a spatial domain using transmission and/or reception beams during certain time interval according to a predefined scheme
Beam measurement operation: an operation in which the UE measures a reference signal (RS) transmitted by a counterpart UE and searches for an RS whose measurement value is equal to or greater than a threshold
Beam selection operation: an operation in which the UE selects a best beam (e.g., reception beam or transmission beam) based on the result of beam measurement
Beam reporting operation: an operation in which the UE reports the selected best beam to the counterpart UE or base station
Beam failure recovery (BFR): an operation of UE that recovers the beam when SL beam failures occur greater than or equal to a threshold.
Beam pairing: an operation to pair the transmission/reception beams between UEs to enable communication through the transmission/reception beams between UEs.

Meanwhile, according to prior art, a UE performing DRX operation may start a DRX onduration timer within a DRX cycle, and the time duration during which the DRX onduration timer is running may correspond to the active time of the UE. The UE may monitor PSCCH/PSSCH during the active time. When the UE receives PSCCH/PSSCH during the active time and a new transmission is indicated through the received PSCCH/PSSCH, the UE may start a DRX inactivity timer to receive the new transmission. When the DRX inactivity timer is started, the active time of the UE may be extended (i.e., the UE operating in an active state due to the start of the DRX onduration timer may remain in the active state due to the start of the DRX inactivity timer). However, for example, when a UE performing DRX operation performs beam-based communication, detection of beam failure for a paired beam does not require performing operations related to PSCCH/PSSCH monitoring (or PSCCH/PSSCH transmission). That is, for example, beam failure detection may be performed during the inactive time of the UE, and beam failure recovery (BFR) procedure may be performed based on the detected beam failure. In this case, for example, the transmission and reception of information (e.g., SCI, MAC CE, or HARQ feedback) for performing the BFR procedure for the paired beam between UEs may occur during the inactive time of the UE. In this case, for example, a problem may arise in which the completion of the BFR procedure is delayed due to the delay in transmitting or receiving information indicating the initiation or success of the BFR procedure. Alternatively, for example, a problem related to inefficient use of resources may arise due to the UE transmitting information related to BFR procedure during the inactive time of counterpart UE. Alternatively, for example, a problem of communication inefficiency may arise due to the UE repeatedly transmitting information related to BFR procedure without knowing the active time of the counterpart UE.

In the present disclosure, a method of UE operating that performs an operation related to DRX active time in consideration of beam failure recovery (BFR) procedure, and a device supporting the same, are proposed as follows.

For example, the UE may perform a recovery operation for beam failure through the following procedure.

For example, when the UE detects a failure of a beam being used for sidelink (SL) communication by a threshold, the UE may trigger SL beam failure recovery (BFR) procedure to perform a procedure for recovering the beam. For example, in the present disclosure, when sidelink (SL) beam failure occurs by a threshold, the beam failure recovery (BFR) operation of the UE may be defined as follows.

For example, when sidelink (SL) beam failure occurs by a threshold, the UE may trigger a beam failure recovery (BFR) operation and perform BFR procedure. For example, when the UE triggers the BFR procedure, the UE may start BFR timer and perform the BFR operation until the BFR timer expires. For example, the BFR timer may be started when the BFR procedure is triggered.

For example, when the BFR is triggered, the UE may start the BFR timer.

Alternatively, for example, when the BFR procedure is triggered and the UE transmits SL BFR MAC CE (e.g., a MAC CE requesting recovery of beam failure or indicating the start of the beam failure recovery procedure) to the counterpart UE, the UE may start the BFR timer.

Alternatively, for example, when the UE receives BFR MAC CE from the counterpart UE, the UE may also trigger the BFR procedure and start the BFR timer.

For example, if the UE receives BFR confirmation MAC CE (e.g., a MAC CE intended to confirm the reception of the BFR MAC CE, or to indicate the success of the BFR operation) before the expiration of the BFR timer, the UE may determine that the BFR procedure has been successfully completed.

In the present disclosure, the UE may perform BFR operations as follows.

For example, when the UE detects that sidelink (SL) beam failure has occurred by a threshold, the UE may transmit BFR MAC CE to the counterpart UE to start the BFR procedure. Additionally, for example, when the UE receives BFR confirmation MAC CE or HARQ feedback from the UE that received the BFR MAC CE, the UE may determine that the BFR procedure has been successful.

For example, when the UE detects that SL beam failure has occurred by a threshold, the UE may transmit BFR MAC CE to the counterpart UE to start the BFR procedure. For example, the UE that received the BFR MAC CE may transmit SCI and sidelink data related to the SCI (e.g., dummy data may be included if there is no data to transmit) or BFR confirmation MAC CE to the UE that transmitted the BFR MAC CE. For example, the UE transmitting the BFR confirmation MAC CE may include the SL HARQ process ID used by the UE that transmitted the BFR MAC CE into the BFR confirmation MAC CE or into the SCI related to the sidelink data (e.g., data transmitted to the UE that transmitted the BFR MAC CE), and may transmit the BFR confirmation MAC CE or the sidelink data to the UE that transmitted the BFR MAC CE. For example, when receiving BFR confirmation MAC CE including the SL HARQ process ID used for its BFR MAC CE transmission or SCI related to sidelink data (e.g., data transmitted to the UE that transmitted the BFR MAC CE) from the counterpart UE, the UE that transmitted the BFR MAC CE may determine that the BFR procedure has been successful. Alternatively, for example, when transmitting the BFR confirmation MAC CE including the SL HARQ process ID used by the counterpart UE (i.e., the UE that transmitted the BFR MAC CE) for transmitting the BFR MAC CE or the SCI related to sidelink data (e.g., data transmitted to the UE that transmitted the BFR MAC CE) to the counterpart UE, the UE that received the BFR MAC CE may determine that the BFR procedure has been successful.

For example, when the UE triggers SL BFR procedure, the UE may transmit SL BFR MAC CE to the counterpart UE. In this case, for example, a sidelink resource pool for transmitting the SL BFR MAC CE of the UE may be independently defined. That is, for example, when the UE triggers the SL BFR procedure, the UE may create a sidelink grant using a dedicated SL resource pool for transmitting the SL BFR MAC CE, and may transmit the SL BFR MAC CE using the created sidelink grant. For example, when receiving HARQ feedback (e.g., ACK) for the transmitted SL BFR MAC CE, the UE that transmitted the SL BFR MAC CE may determine that the BFR has been successful. Additionally, for example, when transmitting SL BFR MAC CE, the UE may transmit with the HARQ feedback option configured to HARQ feedback disabled. Additionally, for example, the UE may select a specific directional beam to be used for transmitting or receiving the SL BFR MAC CE by preconfiguring a specific directional transmission beam/reception beam related to the dedicated SL resource pool or dedicated SL resource block (RB) set for SL BFR MAC CE transmission.

For example, BFR triggering may be independently performed between UEs. For example, for purposes such as transmission/reception beam adjustment from UE A to UE B or transmission/reception beam adjustment from UE B to UE A, the UEs may independently trigger BFR. Additionally, for example, when BFR is triggered at a specific UE, the peer UE may also trigger a sweeping operation of its transmission beam/reception beam based on the received BFR MAC CE.

For example, the UE may trigger SL BFR at the example timings as follows.

For example, the UE may detect SL beam failure by a threshold and directly trigger SL BFR.

For example, when BFR trigger is requested from the counterpart UE through SCI or MAC CE, the UE may trigger SL BFR.

In the present disclosure, various embodiments based on beam failure recovery (BFR) operations are proposed as follows.

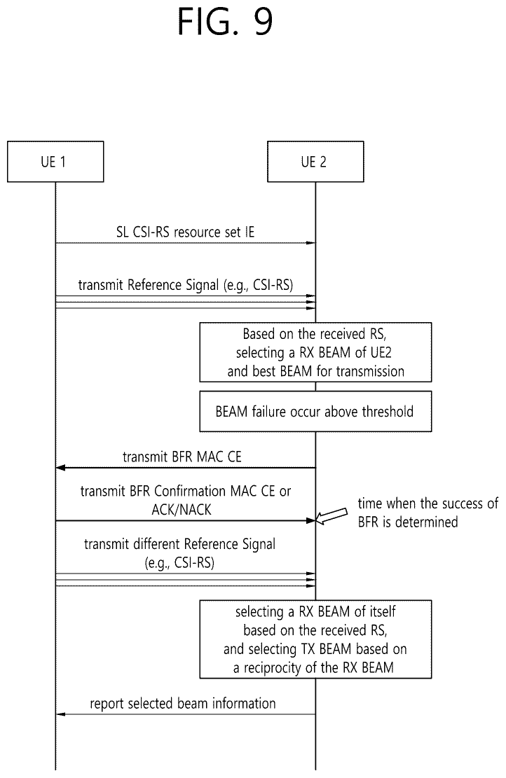

FIG. 9 shows a beam failure recovery (BFR) operation, based on an embodiment of the present disclosure. The embodiment of FIG. 9 may be combined with various embodiments of the present disclosure.

Referring to FIG. 9, for example, UE 1 may be a UE that presents abeam to the counterpart UE (or transmits a reference signal (RS) so that the counterpart UE may select a best beam). For example, UE 2 may be a UE that receives the reference signal (RS) from the UE that presents a beam (or transmits the reference signal (RS) so that the counterpart UE may select a best beam). For example, UE 1 may transmit SL CSI-RS resource set (e.g., information indicating which resources are used for SL CSI-RS transmission) to UE 2. For example, UE 1 may transmit SL CSI-RS for beam management (e.g., beam sweeping and beam pairing) to UE 2. For example, UE 2 may monitor the SL CSI-RS transmitted by UE 1 and may select a reception beam and a transmission beam (e.g., a beam for an RS with a good RSRP value among RSs, where the measured RSRP value is greater than or equal to the threshold) based on the received SL CSI-RS (e.g., based on RSRP measurement of the received SL CSI-RS). For example, UE2 may trigger SL BFR when SL beam failure greater than or equal to a threshold occurs for the selected reception beam or transmission beam and transmit BFR MAC CE to UE 1. For example, the BFR MAC CE transmitted by UE 2 may include an index related to the beam where the beam failure occurred (e.g., an index of the SL CSI-RS related to beam where the beam failure occurred, or a resource index for the SL CSI-RS related to beam where the beam failure occurred), and may further include the RSRP measurement value for the index related to the beam where the beam failure occurred (e.g., an index of the SL CSI-RS related to beam where the beam failure occurred, or a resource index for the SL CSI-RS related to beam where the beam failure occurred). For example, when receiving the BFR MAC CE from UE 2, UE 1 may transmit a new SL CSI-RS (e.g., an RS using a new SL CSI-RS resource) for beam failure recovery (BFR), and may transmit BFR confirmation MAC CE (e.g., a MAC CE for confirming the reception of the BFR MAC CE, or a MAC CE for indicating the success of the BFR operation) to UE 2 either before or after the SL CSI-RS transmission (alternatively, UE 1 may transmit HARQ feedback (ACK or NACK) instead of transmitting the BFR confirmation MAC CE). For example, UE 1/UE 2 may determine that the BFR procedure is successful when transmitting/receiving the BFR confirmation MAC CE (or when transmitting/receiving HARQ feedback for the BFR MAC CE). Alternatively, for example, UE 1 may determine that the BFR is successful when receiving a report message from UE 2 indicating a new best reception beam or transmission beam based on the transmission of the new SL CSI-RS. Alternatively, for example, UE 2 may determine that the BFR is successful when it selects a new best reception beam or transmission beam based on the reception of the new SL CSI-RS and reports it to UE 1.

For example, when the UE detects a failure related to a beam being used for sidelink communication by a threshold, the UE may trigger sidelink beam failure recovery (SL BFR) procedure and perform a procedure for recovering the beam. In the present disclosure, the request-based SL BFR operation from the counterpart UE may be defined as follows.

For example, when the UE receives BFR trigger request from the counterpart UE through SCI or MAC CE, the UE may trigger SL BFR. For example, when the UE receives BFR trigger request from the counterpart UE through SCI or MAC CE, the UE may perform the following operations. For example, UE 1 may transmit SCI or MAC CE to UE 2 to request the initiation of the SL BFR procedure. For example, UE 1 may transmit SCI (or MAC CE) requesting initiation of the SL BFR procedure and may start SL BFR recovery timer. For example, the SL BFR recovery timer (e.g., timer duration) may be negotiated between UEs (e.g., UE 1 and UE 2) through PC5 RRC reconfiguration procedure. For example, when UE 2 receives the SCI or MAC CE requesting the initiation of the SL BFR procedure from UE 1, UE 2 may start the SL BFR recovery timer, and may trigger SL BFR and complete the SL BFR procedure before the timer expires. For example, UE 2 may determine or select a best transmission beam/best reception beam before the timer expires and may report it to UE 1. For example, when UE 2 reports the best transmission beam/best reception beam to UE 1, UE 2 may stop the SL BFR recovery timer and terminate the SL BFR procedure. Alternatively, for example, when UE 1 receives the report of the best transmission beam/best reception beam from UE 2 before the SL BFR recovery timer expires, UE 1 may stop the SL BFR recovery timer and terminate the SL BFR procedure. For example, if the BFR procedure is not completed before the SL BFR recovery timer expires, UE 1 may retransmit the SCI or MAC CE requesting the initiation of the SL BFR procedure to UE 2 and re-trigger the SL BFR procedure. For example, UE 1 may be the UE that transmits (or presents) a reference signal (RS) (e.g., SL CSI-RS) for beam sweeping/beam pairing/beam management for UE 1 and UE 2. Alternatively, for example, UE 2 may be the UE that transmits (or presents) a reference signal (RS) (e.g., SL CSI-RS) for beam sweeping/beam pairing/beam management for UE 1 and UE 2. For example, UE 2 may be the UE that receives a reference signal (RS), determines and selects the best transmission beam/best reception beam, and reports it to the counterpart UE. Alternatively, for example, UE 1 may be the UE that receives a reference signal (RS) (e.g., SL CSI-RS), determines and selects the best transmission beam/best reception beam, and reports it to the counterpart UE. For example, UE 2 may be the UE that transmits a reference signal (RS) (e.g., SL CSI-RS), determines and selects the best transmission beam/best reception beam, and reports it to the counterpart UE. Alternatively, UE 1 may be the UE that transmits a reference signal (RS) (e.g., SL CSI-RS), determines and selects the best transmission beam/best reception beam, and reports it to the counterpart UE.

For example, when the UE receives BFR trigger request from the counterpart UE through SCI or MAC CE, the UE may perform the following operations. For example, UE 1 may transmit SCI or MAC CE to UE 2 indicating that there is a problem with a reference signal (RS) (e.g., SL CSI-RS) for beam sweeping/beam pairing/beam management (e.g., when the RSRP of the RS falls below a threshold). For example, UE 1 may transmit the SCI (or MAC CE) indicating a problem with the RS (e.g., SL CSI-RS) and may start SL BFR recovery timer. For example, the SL BFR recovery timer (e.g., timer duration) may be negotiated between UEs (e.g., between UE 1 and UE 2) through PC5 RRC reconfiguration procedure. For example, when UE 2 receives the SCI (or MAC CE) from UE 1 indicating a problem with the RS (e.g., SL CSI-RS), UE 2 may start the SL BFR recovery timer, trigger SL BFR, and complete the SL BFR procedure before the timer expires. For example, UE 2 (or UE 1) may transmit a new reference signal (RS) to UE 1 (or UE 2) before the timer expires, and UE 1 (or UE 2) may select the best transmission beam/best reception beam based on the new RS transmitted by UE 2 (or UE 1), and report it to UE 2 (or UE 1). For example, when UE 1 (or UE 2) reports the best transmission beam/best reception beam to UE 2 (or UE 1), UE 1 (or UE 2) may stop the SL BFR recovery timer and terminate the SL BFR procedure. Alternatively, for example, when UE 2 (or UE 1) receives the report of the best transmission beam/best reception beam from UE 1 (or UE 2) before the SL BFR recovery timer expires, UE 2 (or UE 1) may stop the SL BFR recovery timer and terminate the SL BFR procedure. For example, if the BFR procedure is not completed before the SL BFR recovery timer expires, UE 1 (or UE 2) may retransmit the SCI (or MAC CE) indicating a problem with the RS (e.g., SL CSI-RS) to UE 2 (or UE 1) to re-trigger the SL BFR procedure. For example, UE 1 may be the UE that transmits (or presents) a reference signal (RS) (e.g., SL CSI-RS) for beam sweeping/beam pairing/beam management for UE 1 and UE 2. Alternatively, UE 2 may be the UE that transmits (or presents) a reference signal (RS) for beam sweeping/beam pairing/beam management for UE 1 and UE 2. For example, UE 2 may be the UE that receives a reference signal (RS) (e.g., SL CSI-RS), determines and selects the best transmission beam/best reception beam, and reports it to the counterpart UE. Alternatively, for example, UE 1 may be the UE that receives a reference signal (RS) (e.g., SL CSI-RS), determines and selects the best transmission beam/best reception beam, and reports it to the counterpart UE. For example, UE 2 may be the UE that transmits a reference signal (RS) (e.g., SL CSI-RS), determines and selects the best transmission beam/best reception beam, and reports it to the counterpart UE. Alternatively, UE 1 may be the UE that transmits a reference signal (RS) (e.g., SL CSI-RS), determines and selects the best transmission beam/best reception beam, and reports it to the counterpart UE.

Meanwhile, in the present disclosure, it is proposed to define the duration in which beam failure recovery is performed as the SL DRX active time, so that a UE supporting DRX operation (e.g., a transmitting UE or a receiving UE) performs DRX active time operation accordingly (For example, the receiving UE may monitor PSCCH/PSSCH during the DRX active time to receive data transmitted by the transmitting UE. Alternatively, for example, the transmitting UE may transmit PSCCH/PSSCH during the DRX active time of the receiving UE to ensure that the receiving UE can reliably receive the transmitted data.).

For example, the UE (e.g., a transmitting UE or a receiving UE) may perform SL DRX active time operation by considering the following period as the SL DRX active time, and may operate in sleep mode during periods outside the DRX active time.

For example, the UE may perform SL DRX active time operation from the time the SL BFR procedure is triggered to the time the SL BFR procedure is completed.

For example, the UE may perform SL DRX active time operation from the time the SL BFR MAC CE is triggered (e.g., when the UE itself triggers the SL BFR procedure) or from the time the SL BFR MAC CE is transmitted (e.g., when the UE transmits the SL BFR MAC CE after triggering the SL BFR procedure) to the time the UE receives SL BFR confirmation MAC CE (e.g., MAC CE for the purpose of indicating that the SL BFR process is complete or MAC CE for the purpose of acknowledgement (ACK) for the receipt of SL BFR MAC CE).

For example, the UE may perform SL DRX active time operation from the time the SL BFR MAC CE is triggered (e.g., the time the UE receives a request from the counterpart UE to trigger the SL BFR procedure) or from the time the SL BFR MAC CE is transmitted (e.g., the UE transmits the SL BFR MAC CE in response to BFR trigger request from the counterpart UE) to the time the UE receives SL BFR confirmation MAC CE (e.g., MAC CE for the purpose of indicating that the SL BFR process is complete or MAC CE for the purpose of acknowledgement (ACK) for the receipt of SL BFR MAC CE).

For example, the UE may perform SL DRX active time operation from the time the SL BFR MAC CE is triggered (e.g., the time the UE receives a request from the counterpart UE to trigger the SL BFR procedure) or from the time the UE receives the SL BFR MAC CE from the counterpart UE, to the time the UE transmits SL BFR confirmation MAC CE (e.g., MAC CE for the purpose of indicating that the SL BFR process is complete or MAC CE for the purpose of acknowledgement (ACK) for the receipt of SL BFR MAC CE).

For example, the UE may perform SL DRX active time operation during the period in which the SL BFR recovery timer is running.

For example, the UE may perform SL DRX active time operation from the time the SL BFR process is triggered until the SL BFR process ends (e.g., ends with SL BFR success, or ends with SL BFR process failure).

For example, the UE may perform SL DRX active time operation from the time it transmits a request message to the counterpart UE for transmitting a beam or beam-related reference signal (RS) resource, or triggers a request message to the counterpart UE for transmitting a beam or beam-related RS resource, to the time it completes the selection of a (best) beam or beam-related RS resource to use, based on reception of the beam or beam-related RS resource transmitted by the counterpart UE. Alternatively, for example, if the request and response procedure for the beam or beam-related RS resource operates based on a timer, the UE may start the timer at the time it triggers or transmits the request message for the beam or beam-related RS resource to the counterpart UE (e.g., the UE may re-receive the beam or beam-related RS resource from the counterpart UE before the timer expires, and complete the selection of the (best) beam or beam-related RS resource to use), and may perform SL DRX active time operation during the period until the timer expires.

For example, the UE may perform SL DRX active time operation from the time it receives a beam or beam-related reference signal (RS) resource transmission request message from the counterpart UE, or receives a request for beam or beam-related RS resource transmission, to the time it transmits the beam or beam-related RS resource to the counterpart UE and the counterpart UE completes the selection of the (best) beam or beam-related RS resource to use.

For example, the UE may perform SL DRX active time operation during the period in which the beam pairing procedure between UEs is being performed.

For example, when the beam failure recovery (BFR) procedure fails, the UE may operate in DRX active time (or in wakeup mode) and perform an operation of establishing a new sidelink session, such as establishing another unicast session.

For example, when beam failure instance (BFI) (e.g., the PHY layer reports BFI to the MAC layer when beam failure is detected on all beams used by the UE) occurs by a maximum threshold in a non-DRX active time period (e.g., a period in which the UE does not monitor PSCCH/PSSCH transmitted by the counterpart UE and does not transmit or receive logical channel data, MAC CEs, or PC5 RRC messages), and BFR (beam failure recovery) is triggered, the UE may transition to a DRX active time period (e.g., a period in which the UE monitors PSCCH/PSSCH transmitted by the counterpart UE and transmits or receives logical channel data, MAC CE, or PC5 RRC message), and may trigger and perform the BFR procedure.

For example, when beam failure instance (BFI) (e.g., the PHY layer reports BFI to the MAC layer when beam failure is detected on all beams used by the UE) occurs in a non-DRX active time period (e.g., a period during which the UE does not monitor PSCCH/PSSCH transmitted by the counterpart UE and does not transmit or receive logical channel data, MAC CE, or PC5 RRC message), the UE may transition to a DRX active time period (e.g., a period during which the UE monitors PSCCH/PSSCH transmitted by the counterpart UE and transmits or receives logical channel data, MAC CE, or PC5 RRC message) and may perform operations such as receiving beams or beam-related RS resources transmitted by the counterpart UE and performing measurement on those beams or beam-related RS resources.

For example, the UE may operate in DRX active time from the time after beam sweeping is completed. For example, in order to quickly receive feedback (e.g., information on the selected best beam (to be used or a candidate) or RS resource related to the selected beam, and measurement report on the beam or beam-related RS resource, etc.) from the counterpart UE after beam sweeping is completed and perform communication using the best beam, the UE may operate in the SL DRX active time after the beam sweeping operation is completed to monitor the signal or message of the counterpart UE.

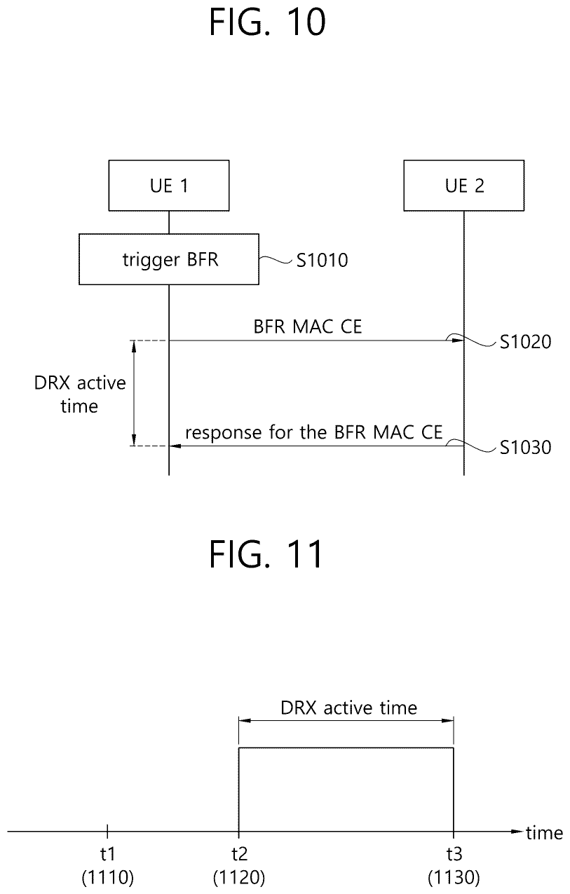

FIG. 10 shows a beam failure recovery (BFR) operation considering DRX active time, based on an embodiment of the present disclosure. The embodiment of FIG. 10 may be combined with various embodiments of the present disclosure.

Referring to FIG. 10, UE 1 and UE 2 may be UEs that have obtained beam-related configuration information and DRX-related configuration information. For example, a beam-related reference signal (RS) may be transmitted and received during the DRX active time of UE 1 and UE 2, and based on the transmitted and received beam-related RS, UE 1 and UE 2 may perform beam pairing.

In step S1010, UE 1 may trigger beam failure recovery (BFR) procedure. For example, UE 1 may detect beam failure related to a beam paired with UE 2, and may trigger the BFR procedure based on the number of detected beam failures reaching a threshold. For example, while UE 1 directly detects the beam failure, monitoring of PSCCH or PSSCH may not be performed. That is, for example, UE 1 may operate in a DRX inactive state while directly detecting the beam failure and triggering the BFR procedure. Alternatively, for example, the BFR procedure may be triggered based on UE 1 receiving information from UE 2 requesting the initiation of the BFR procedure.

In step S1020, UE 1 may transmit a BFR MAC CE to UE 2 based on the triggering of the BFR procedure. For example, UE 1 may operate in an active state starting from the time it transmits the BFR MAC CE. For example, the time before the transmission of the BFR MAC CE may correspond to the DRX inactive time of UE 1, and the time after the transmission may correspond to the DRX active time of UE 1. That is, for example, based on the transmission of the BFR MAC CE, the DRX inactive time of UE 1 may change to DRX active time. In this case, for example, UE 2 may also operate in an active state starting from the time it receives the BFR MAC CE from UE 1. That is, for example, based on the reception of the BFR MAC CE, the DRX inactive time of UE 2 may change to DRX active time. For example, after the transmission of the BFR MAC CE, during the active time of UE 1, UE 1 may monitor PSCCH or PSSCH to receive a response from UE 2 indicating the successful reception of the BFR MAC CE (e.g., HARQ feedback). In this case, for example, during the active time of UE 2 following the reception of the BFR MAC CE, UE 2 may transmit the response (e.g., HARQ feedback) indicating successful reception of the BFR MAC CE to UE 1 through PSCCH or PSSCH. Alternatively, for example, after the transmission of the BFR MAC CE, during the active time of UE 1, UE 1 may monitor PSCCH or PSSCH to receive RS related to a beam other than the beam where failure occurred, from UE 2. In this case, for example, during the active time of UE 2 after receiving the BFR MAC CE, UE 2 may transmit RS related to a beam other than the failed beam to UE 1 through PSCCH or PSSCH. Alternatively, as will be described later, after the transmission of the BFR MAC CE, during the active time of UE 1, UE 1 may monitor PSCCH or PSSCH to receive a response (e.g., BFR confirmation MAC CE or HARQ feedback) from UE 2 indicating the success of the BFR procedure. In this case, for example, during the active time of UE 2 after receiving the BFR MAC CE, UE 2 may transmit a response (e.g., BFR confirmation MAC CE or HARQ feedback) to UE 1 through PSCCH or PSSCH indicating the success of the BFR procedure.

In step S1030, UE 1 may receive a response from UE 2 to the BFR MAC CE transmitted in step S1020 described above. For example, the UE 1 may operate in an inactive state again from the time it receives a response to the BFR MAC CE. That is, based on the reception of the response to the BFR MAC CE, the DRX active time of UE 1 may change back to DRX inactive time. In this case, for example, UE 2 may also return to an inactive state from the time it transmits a response to the BFR MAC CE. That is, based on the transmission of the response to the BFR MAC CE, the DRX active time of UE 2 may change back to DRX inactive time. For example, after receiving the response to the BFR MAC CE, UE 1 may perform beam selection and beam pairing based on the newly received beam-related RS in step S1020, without monitoring PSCCH or PSSCH for other beam-related RS. For example, through the above operation, a UE that performs both beam-related and DRX-related operations may operate in an active state while information related to the BFR procedure is transmitted and received. Accordingly, for example, it is possible to prevent a problem of delay in completion of a BFR procedure that may occur due to transmission and reception of information related to a triggered BFR or information for indicating the success of a BFR during a time period in which the UE operates in sleep mode. Alternatively, for example, it is possible to prevent a problem of inefficient power and resource usage caused by repeatedly attempting the transmission and reception of such information until they occur during the active time of the UE.

FIG. 11 shows a beam failure recovery (BFR) operation considering DRX active time, based on an embodiment of the present disclosure. The embodiment of FIG. 11 may be combined with various embodiments of the present disclosure.

Referring to FIG. 11, for example, the UE may trigger BFR at time t1 1110, transmit a BFR MAC CE to the counterpart UE at time t2 1120, and receive a response to the BFR MAC CE (e.g., BFR confirmation MAC CE or MAC CE including ACK information) from the counterpart UE at time t3 1130. In this case, for example, the time period between the time point t2 1120 and the time point t3 1130 may be the DRX active time of the UE.

Alternatively, for example, unlike the above, the UE may trigger BFR at time point t2 1120 and initiate a BFR timer, and the initiated BFR timer may expire at time point t3 1130. In this case, the time period between the time point t2 1120 and the time point t3 1130, which is the time period during which the BFR timer is running, may be the DRX active time of the UE.

Alternatively, for example, unlike the above, the UE may transmit information for requesting beam-related information (e.g., information related to a beam-related reference signal (RS) or information for the beam-related RS) to the counterpart UE at time point t2 1120, and may select a new beam based on the beam-related information received from the counterpart UE at time point t3 1130. In this case, for example, the time period between the time point t2 1120 and the time point t3 1130 may be the DRX active time of the UE.

Alternatively, for example, unlike the above, the UE may detect a beam failure for a previously selected beam at time point t1 1110, may trigger BFR based on that the number of detected beam failures reaches a threshold (e.g., the number of beam failure instances (BFIs) transferred the PHY layer of the UE to the MAC layer of the UE reaches the threshold) at time point t2 1120, and the triggered BFR may be completed at time point t3 1130. In this case, for example, the DRX inactive time of the UE before and after the time point t2 1120 may be changed to the DRX active time, and the time period between the time point t2 1120 and the time point t3 1130 may be the DRX active time of the UE.

For example, in SL FR2, a UE supporting DRX may skip the transmission of the PSFCH if the quality related to the beam or RS resource related to the transmission of the PSFCH falls below a preconfigured threshold before transmitting the PSFCH after receiving the PSCCH/PSSCH, or if SL beam failure recovery (BFR) is triggered before the transmission of the PSFCH. In addition, for example, the SL DRX HARQ RTT timer may be started (or, for example, the SL DRX HARQ RTT timer may not be started).

For example, in SL FR2, a UE supporting DRX may perform the transmission of the PSFCH if the quality related to the beam or RS resource related to the transmission of the PSFCH falls below a preconfigured threshold before transmitting the PSFCH after receiving the PSCCH/PSSCH, or if SL beam failure recovery (BFR) is triggered before the transmission of the PSFCH. In addition, for example, the SL DRX HARQ RTT timer may be started (or, the SL DRX HARQ RTT timer may not be started).

In embodiments of the present disclosure, the beam management operation may be interpreted as being replaced by beam selection, spatial filter selection, beam pairing, spatial filter pairing, beam failure recovery, spatial filter recovery, beam sweeping, spatial filter sweeping, beam switching, spatial filter switching, measurement of reference signal (RS) resource, measurement report of reference signal (RS) resource, beam report, or spatial filter report, etc.

In embodiments of the present disclosure, a beam may be interpreted as being replaced by an RS, an RS resource, or a spatial filter resource.

In embodiments of the present disclosure, an RS may be interpreted as being replaced by an RS resource or a spatial filter resource.

In embodiments of the present disclosure, the transmitting UE may be interpreted as being replaced by a UE transmitting a beam, a UE transmitting a reference signal (RS) or a UE transmitting reference signal (RS) resource.

In embodiments of the present disclosure, the receiving UE may be interpreted as being replaced by a UE receiving a beam, a UE receiving a reference signal (RS) or a UE receiving reference signal (RS) resource.

In embodiments of the present disclosure, transmission beam or reception beam information transmitted or received by the UE may be interpreted as being replaced by resource information of reference signal (RS) related to the transmission beam or resource information of reference signal (RS) related to the reception beam.

In embodiments of the present disclosure, direct communication request (DCR) and/or direct communication accept (DCA) message may be interpreted as being replaced by PC5-S DCR and/or PC5-S DCA message, etc.

In embodiments of the present disclosure, although the proposals are described based on SL CSI-RS as an example of an RS for beam management, the operations proposed in the present disclosure may equally be extended and applied to cases where reference signals (RSs) other than SL CSI-RS (e.g., SL SSB) are used for beam management.

In embodiments of the present disclosure, although the proposals are described based on reference signal received power (RSRP) as an example of an RS measurement for beam management, the operations proposed in the present disclosure may equally be extended and applied to cases where other measurement operations (e.g., received signal strength indicator (RSSI) measurement) are used as RS measurements for beam management.

In embodiments of the present disclosure, spatial setting and/or transmission configuration indication (TCI) information and/or quasi co location (QCL) information and/or beam may refer to each other, and may be interpreted as being replaced by beam-related information, beam direction or spatial domain transmission/reception filter.

In embodiments of the present disclosure, a beam may be interpreted as being replaced by a transmission beam, a reception beam, a spatial filter, a spatial transmission (TX) filter, a spatial domain transmission (TX) filter, a spatial reception (RX) filter, or a spatial domain reception (RX) filter.

In embodiments of the present disclosure, a transmission beam may be interpreted as being replaced by a spatial transmission (TX) filter or a spatial domain transmission (TX) filter.

In embodiments of the present disclosure, a reception beam may be interpreted as being replaced by a spatial reception (RX) filter or a spatial domain reception (RX) filter.

In embodiments of the present disclosure, that spatial setting information for transmission (or beam information) is same may mean that the spatial domain transmission (TX) filter of UE is same for two different transmission signals. In embodiments of the present disclosure, that spatial setting information (or beam information) for reception is same may means that the two different reception signals may have a QCL TypeD relationship and/or a relationship using a same spatial reception (RX) parameter.

The operations of the present disclosure may be applied to sidelink unicast, groupcast, and broadcast operations.

For example, whether or not the (some) proposed method/rule of the present disclosure is applied and/or related parameter(s) (e.g., threshold value(s)) may be configured (differently or independently) for each SL-Channel Access Priority Class (CAPC). For example, whether or not the (some) proposed method/rule of the present disclosure is applied and/or related parameter(s) (e.g., threshold value(s)) may be configured (differently or independently) for each SL-LBT type (e.g., Type 1 LBT, Type 2A LBT, Type 2B LBT, Type 2C LBT). For example, whether or not the (some) proposed method/rule of the present disclosure is applied and/or related parameter(s) (e.g., threshold value(s)) may be configured specifically (or differently or independently) depending on whether or not Frame Based LBT is applied. For example, whether or not the (some) proposed method/rule of the present disclosure is applied and/or related parameter(s) (e.g., threshold value(s)) may be configured specifically (or differently or independently) depending on whether or not Load Based LBT is applied.

For example, whether or not the (some) proposed method/rule of the present disclosure is applied and/or related parameter(s) (e.g., threshold value(s)) may be configured (differently or independently) for each resource pool. For example, whether or not the (some) proposed method/rule of the present disclosure is applied and/or related parameter(s) (e.g., threshold value(s)) may be configured (differently or independently) for each congestion level. For example, whether or not the (some) proposed method/rule of the present disclosure is applied and/or related parameter(s) (e.g., threshold value(s)) may be configured (differently or independently) for each service priority. For example, whether or not the (some) proposed method/rule of the present disclosure is applied and/or related parameter(s) (e.g., threshold value(s)) may be configured (differently or independently) for each service type. For example, whether or not the (some) proposed method/rule of the present disclosure is applied and/or related parameter(s) (e.g., threshold value(s)) may be configured (differently or independently) for each QoS requirement (e.g., latency, reliability). For example, whether or not the (some) proposed method/rule of the present disclosure is applied and/or related parameter(s) (e.g., threshold value(s)) may be configured (differently or independently) for each PQI (5G QoS identifier (5QI) for PC5). For example, whether or not the (some) proposed method/rule of the present disclosure is applied and/or related parameter(s) (e.g., threshold value(s)) may be configured (differently or independently) for each traffic type (e.g., periodic generation or aperiodic generation). For example, whether or not the (some) proposed method/rule of the present disclosure is applied and/or related parameter(s) (e.g., threshold value(s)) may be configured (differently or independently) for each SL transmission resource allocation mode (e.g., mode 1 or mode 2). For example, whether or not the (some) proposed method/rule of the present disclosure is applied and/or related parameter(s) (e.g., threshold value(s)) may be configured (differently or independently) for each Tx profile (e.g., a Tx profile indicating that a service supports sidelink DRX operation or a Tx profile indicating that a service does not need to support sidelink DRX operation).

For example, whether or not the proposed rule of the present disclosure is applied and/or related parameter configuration value(s) may be configured (differently or independently) depending on the activation/deactivation of the Uu Bandwidth part. For example, whether or not the proposed rule of the present disclosure is applied and/or related parameter configuration value(s) may be configured (differently or independently) depending on whether the Sidelink Bandwidth part is activated or deactivated. For example, whether or not the proposed rule of the present disclosure is applied and/or related parameter configuration value(s) may be configured (differently or independently) for a sidelink logical channel/logical channel group (or Uu logical channel or Uu logical channel group). For example, whether or not the proposed rule of the present disclosure is applied and/or related parameter configuration value(s) may be configured (differently or independently) of the initial transmission resource selection. For example, whether or not the proposed rule of the present disclosure is applied and/or related parameter configuration value(s) may be configured (differently or independently) of the retransmission resource selection. For example, whether or not the proposed rule of the present disclosure is applied and/or related parameter configuration value(s) may be configured (differently or independently) depending on whether the PUCCH configuration is supported (e.g., in case that a PUCCH resource is configured or in case that a PUCCH resource is not configured). For example, whether or not the proposed rule of the present disclosure is applied and/or related parameter configuration value(s) may be configured (differently or independently) for each resource pool (e.g., a resource pool with a PSFCH or a resource pool without a PSFCH). For example, whether or not the proposed rule of the present disclosure is applied and/or related parameter configuration value(s) may be configured (differently or independently) for each service/packet type. For example, whether or not the proposed rule of the present disclosure is applied and/or related parameter configuration value(s) may be configured (differently or independently) for each service/packet priority. For example, whether or not the proposed rule of the present disclosure is applied and/or related parameter configuration value(s) may be configured (differently or independently) for each QoS requirement (e.g., URLLC/EMBB traffic, reliability, latency). For example, whether or not the proposed rule of the present disclosure is applied and/or related parameter configuration value(s) may be configured (differently or independently) for each PQI. For example, whether or not the proposed rule of the present disclosure is applied and/or related parameter configuration value(s) may be configured (differently or independently) for each PFI. For example, whether or not the proposed rule of the present disclosure is applied and/or related parameter configuration value(s) may be configured (differently or independently) for each cast type (e.g., unicast, groupcast, broadcast). For example, whether or not the proposed rule of the present disclosure is applied and/or related parameter configuration value(s) may be configured (differently or independently) for each (resource pool) congestion level (e.g., CBR). For example, whether or not the proposed rule of the present disclosure is applied and/or related parameter configuration value(s) may be configured (differently or independently) for each SL HARQ feedback option (e.g., NACK-only feedback, ACK/NACK feedback). For example, whether or not the proposed rule of the present disclosure is applied and/or related parameter configuration value(s) may be configured specifically (or differently or independently) for HARQ Feedback Enabled MAC PDU transmission. For example, whether or not the proposed rule of the present disclosure is applied and/or related parameter configuration value(s) may be configured specifically (or differently or independently) for HARQ Feedback Disabled MAC PDU transmission. For example, whether or not the proposed rule of the present disclosure is applied and/or related parameter configuration value(s) may be configured specifically (or differently or independently) according to whether a PUCCH-based SL HARQ feedback reporting operation is configured or not. For example, whether or not the proposed rule of the present disclosure is applied and/or related parameter configuration value(s) may be configured specifically (or differently or independently) for pre-emption or depending on whether or not pre-emption-based resource reselection is performed. For example, whether or not the proposed rule of the present disclosure is applied and/or related parameter configuration value(s) may be configured specifically (or differently or independently) for re-evaluation or depending on whether or not re-evaluation-based resource reselection is performed. For example, whether or not the proposed rule of the present disclosure is applied and/or related parameter configuration value(s) may be configured (differently or independently) for each (L2 or L1) (source and/or destination) identifier. For example, whether or not the proposed rule of the present disclosure is applied and/or related parameter configuration value(s) may be configured (differently or independently) for each (L2 or L1) (a combination of source ID and destination ID) identifier. For example, whether or not the proposed rule of the present disclosure is applied and/or related parameter configuration value(s) may be configured (differently or independently) for each (L2 or L1) (a combination of a pair of source ID and destination ID and a cast type) identifier. For example, whether or not the proposed rule of the present disclosure is applied and/or related parameter configuration value(s) may be configured (differently or independently) for each direction of a pair of source layer ID and destination layer ID. For example, whether or not the proposed rule of the present disclosure is applied and/or related parameter configuration value(s) may be configured (differently or independently) for each PC5 RRC connection/link. For example, whether or not the proposed rule of the present disclosure is applied and/or related parameter configuration value(s) may be configured specifically (or differently or independently) depending on whether or not SL DRX is performed. For example, whether or not the proposed rule of the present disclosure is applied and/or related parameter configuration value(s) may be configured specifically (or differently or independently) depending on whether or not SL DRX is supported. For example, whether or not the proposed rule of the present disclosure is applied and/or related parameter configuration value(s) may be configured (differently or independently) for each SL mode type (e.g., resource allocation mode 1 or resource allocation mode 2). For example, whether or not the proposed rule of the present disclosure is applied and/or related parameter configuration value(s) may be configured specifically (or differently or independently) for the case of performing (a)periodic resource reservation. For example, whether or not the proposed rule of the present disclosure is applied and/or related parameter configuration value(s) may be configured specifically (or differently or independently) for each Tx profile (e.g., a Tx profile indicating that a service supports sidelink DRX operation or a Tx profile indicating that a service does not need to support sidelink DRX operation).

The proposal and whether or not the proposal rule of the present disclosure is applied (and/or related parameter configuration value(s)) may also be applied to a mmWave SL operation.

According to various embodiments of the present disclosure, when a UE performing DRX operation performs beam-based communication, the UE may maintain an active time during the BFR procedure. Specifically, for example, in the BFR procedure, during a period in which monitoring of PSCCH/PSSCH (or transmission of PSCCH/PSSCH) is not required, the UE may operate in an inactive state, and during a period in which monitoring of PSCCH/PSSCH (or transmission of PSCCH/PSSCH) is required, the UE may operate in an active state. In this case, for example, it may be ensured that transmission and reception of information related to the BFR procedure transmitted and received in relation to the triggered BFR procedure is performed within the active time of the UE. Alternatively, for example, the UE performing the BFR procedure may use power efficiently. Alternatively, for example, repetitive transmission of information related to the BFR procedure may be prevented. Alternatively, for example, a problem in which completion of the BFR procedure is delayed may be prevented.

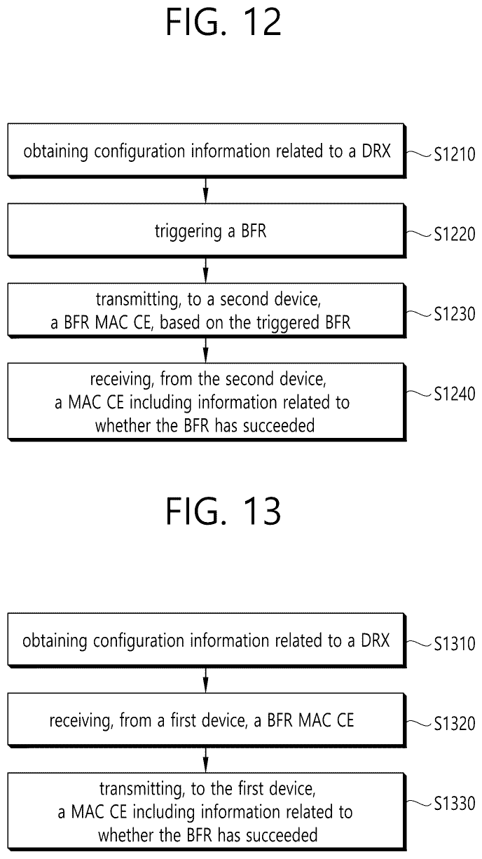

FIG. 12 shows a method for performing wireless communication by a first device, based on an embodiment of the present disclosure. The embodiment of FIG. 12 may be combined with various embodiments of the present disclosure.

Referring to FIG. 12, in step S1210, a first device may obtain configuration information related to a discontinuous reception (DRX). In step S1220, the first device may trigger a beam failure recovery (BFR). In step S1230, the first device may transmit, to a second device, a BFR medium access control (MAC) control element (CE), based on the triggered BFR. In step S1240, the first device may receive, from the second device, a MAC CE including information related to whether the BFR has succeeded. For example, a time duration between the transmission of the BFR MAC CE and the reception of the MAC CE including information related to whether the BFR has succeeded may be an active time of the first device.

For example, MAC CE including information related to whether the BFR has succeeded may be at least one of (i) a BFR confirmation MAC CE, or (ii) a MAC CE including acknowledgement (ACK) information related to a reception of the BFR MAC CE.

For example, the BFR may be triggered based on a number of beam failures detected within an inactive time of the first device reaching a threshold value, and a time after the BFR is triggered may be the active time of the first device. For example, the inactive time of the first device may be changed to the active time of the first device, based on the triggered BFR.

Additionally, for example, the first device may transmit, to the second device, information for requesting information related to a beam, and the first device may receive, from the second device, the information related to the beam. For example, a time duration between a time when the information for requesting information related to the beam is transmitted and a time when a beam selection is completed based on the received information related to the beam may be the active time of the first device. For example, the information related to the beam may include information at least one of (i) at least one beam, (ii) a reference signal (RS) related to the at least one beam, or (iii) resource for the RS. For example, a timer may be started based on the transmission of the information for requesting information related to the beam, and a time duration during which the timer is running may be the active time of the first device.

Additionally, for example, the first device may determine a failure of the BFR. For example, a time after the determination related to the failure of the BFR may be the active time of the first device. For example, based on the failure of the BFR being related to a first session between the first device and the second device, a second session between the first device and the second device may be established at the active time.

Additionally, for example, the first device may perform a beam sweeping. For example, a time after the beam sweeping is completed may be the active time of the first device.

For example, the BFR may be triggered based on receiving requesting information from the second device, and the requesting information may be received based on at least one of control information or a MAC CE. For example, a timer may be started based on the reception of the requesting information from the second device, and a time duration during which the timer is running may be the active time of the first device.

For example, a monitoring related to at least one of a physical control channel or a physical shared channel may be performed at the active time of the first device.

The proposed method may be applied to devices according to various embodiments of the present disclosure. First, a processor 102 of a first device 100 may control a transceiver 106 to ~. And, the processor 102 of the first device 100 may control the transceiver 106 to obtain configuration information related to a discontinuous reception (DRX). And, the processor 102 of the first device 100 may trigger a beam failure recovery (BFR). And, the processor 102 of the first device 100 may control the transceiver 106 to transmit, to a second device, a BFR medium access control (MAC) control element (CE), based on the triggered BFR. And, the processor 102 of the first device 100 may control the transceiver 106 to receive, from the second device, a MAC CE including information related to whether the BFR has succeeded. For example, a time duration between the transmission of the BFR MAC CE and the reception of the MAC CE including information related to whether the BFR has succeeded may be an active time of the first device.

According to one embodiment of the present disclosure, provided is a first device configured to perform wireless communication. The first device may comprise: at least one transceiver; at least one processor; and at least one memory connected to the at least one processor and storing instructions. For example, the instructions, based on being executed by the at least one processor, cause the first device to perform operations comprising: obtaining configuration information related to a discontinuous reception (DRX); triggering a beam failure recovery (BFR); transmitting, to a second device, a BFR medium access control (MAC) control element (CE), based on the triggered BFR; and receiving, from the second device, a MAC CE including information related to whether the BFR has succeeded. For example, a time duration between the transmission of the BFR MAC CE and the reception of the MAC CE including information related to whether the BFR has succeeded may be an active time of the first device.

According to one embodiment of the present disclosure, provided is a processing device configured to control a first device. The processing device may comprise: at least one processor; and at least one memory connected to the at least one processor and storing instructions. For example, the instructions, based on being executed by the at least one processor, cause the first device to perform operations comprising: obtaining configuration information related to a discontinuous reception (DRX); triggering a beam failure recovery (BFR); transmitting, to a second device, a BFR medium access control (MAC) control element (CE), based on the triggered BFR; and receiving, from the second device, a MAC CE including information related to whether the BFR has succeeded. For example, a time duration between the transmission of the BFR MAC CE and the reception of the MAC CE including information related to whether the BFR has succeeded may be an active time of the first device.

According to one embodiment of the present disclosure, provided is a non-transitory computer-readable storage medium recording instructions. For example, the instructions, based on being executed, cause a first device to perform operations comprising: obtaining configuration information related to a discontinuous reception (DRX); triggering a beam failure recovery (BFR); transmitting, to a second device, a BFR medium access control (MAC) control element (CE), based on the triggered BFR; and receiving, from the second device, a MAC CE including information related to whether the BFR has succeeded. For example, a time duration between the transmission of the BFR MAC CE and the reception of the MAC CE including information related to whether the BFR has succeeded may be an active time of the first device.

FIG. 13 shows a method for performing wireless communication by a second device, based on an embodiment of the present disclosure. The embodiment of FIG. 13 may be combined with various embodiments of the present disclosure.

Referring to FIG. 13, In step S1310, a second device may obtain configuration information related to a discontinuous reception (DRX). In step S1320, the second device may receive, from a first device, a beam failure recovery (BFR) medium access control (MAC) control element (CE). In step S1330, the second device may transmit, to the first device, a MAC CE including information related to whether the BFR has succeeded. For example, a time duration between the reception of the BFR MAC CE and the transmission of the MAC CE including information related to whether the BFR has succeeded may be an active time of the second device.

The proposed method may be applied to devices according to various embodiments of the present disclosure. First, a processor 202 of a second device 200 may control a transceiver 206 to obtain configuration information related to a discontinuous reception (DRX). And, the processor 202 of the second device 200 may control the transceiver 206 to receive, from a first device, a beam failure recovery (BFR) medium access control (MAC) control element (CE). And, the processor 202 of the second device 200 may control the transceiver 206 to transmit, to the first device, a MAC CE including information related to whether the BFR has succeeded. For example, a time duration between the reception of the BFR MAC CE and the transmission of the MAC CE including information related to whether the BFR has succeeded may be an active time of the second device.

According to one embodiment of the present disclosure, provided is a second device configured to perform wireless communication. The second device may comprise: at least one transceiver; at least one processor; and at least one memory connected to the at least one processor and storing instructions. For example, the instructions, based on being executed by the at least one processor, cause the second device to perform operations comprising: obtaining configuration information related to a discontinuous reception (DRX); receiving, from a first device, a beam failure recovery (BFR) medium access control (MAC) control element (CE); and transmitting, to the first device, a MAC CE including information related to whether the BFR has succeeded. For example, a time duration between the reception of the BFR MAC CE and the transmission of the MAC CE including information related to whether the BFR has succeeded may be an active time of the second device.

According to one embodiment of the present disclosure, provided is a processing device configured to control a second device. The processing device may comprise: at least one processor; and at least one memory connected to the at least one processor and storing instructions. For example, the instructions, based on being executed by the at least one processor, cause the second device to perform operations comprising: obtaining configuration information related to a discontinuous reception (DRX); receiving, from a first device, a beam failure recovery (BFR) medium access control (MAC) control element (CE); and transmitting, to the first device, a MAC CE including information related to whether the BFR has succeeded. For example, a time duration between the reception of the BFR MAC CE and the transmission of the MAC CE including information related to whether the BFR has succeeded may be an active time of the second device.

According to one embodiment of the present disclosure, provided is a non-transitory computer-readable storage medium recording instructions. For example, the instructions, based on being executed, cause a second device to perform operations comprising: obtaining configuration information related to a discontinuous reception (DRX); receiving, from a first device, a beam failure recovery (BFR) medium access control (MAC) control element (CE); and transmitting, to the first device, a MAC CE including information related to whether the BFR has succeeded. For example, a time duration between the reception of the BFR MAC CE and the transmission of the MAC CE including information related to whether the BFR has succeeded may be an active time of the second device.

Various embodiments of the present disclosure may be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

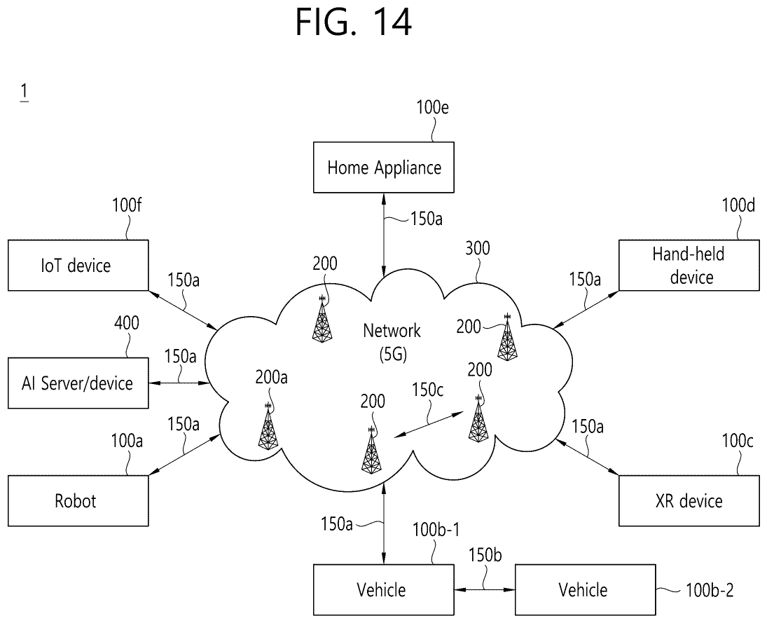

FIG. 14 shows a communication system 1, based on an embodiment of the present disclosure. The embodiment of FIG. 14 may be combined with various embodiments of the present disclosure.

Referring to FIG. 14, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone) and/or Aerial Vehicle (AV) (e.g., Advanced Air Mobility (AAM)). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (JAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

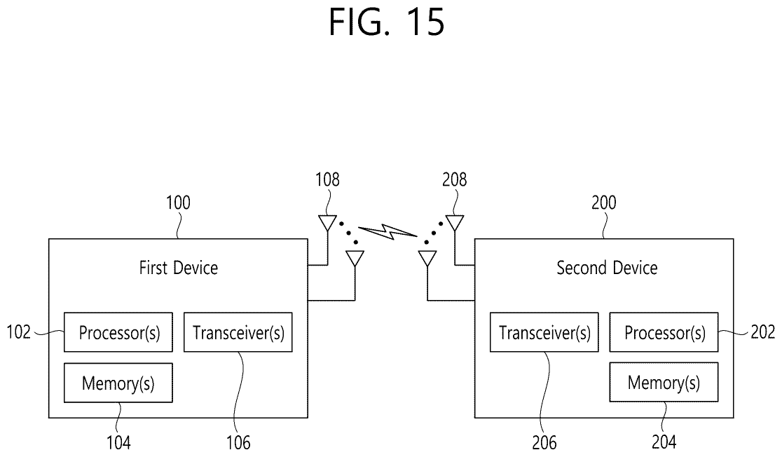

FIG. 15 shows wireless devices, based on an embodiment of the present disclosure. The embodiment of FIG. 15 may be combined with various embodiments of the present disclosure.

Referring to FIG. 15, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 14.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

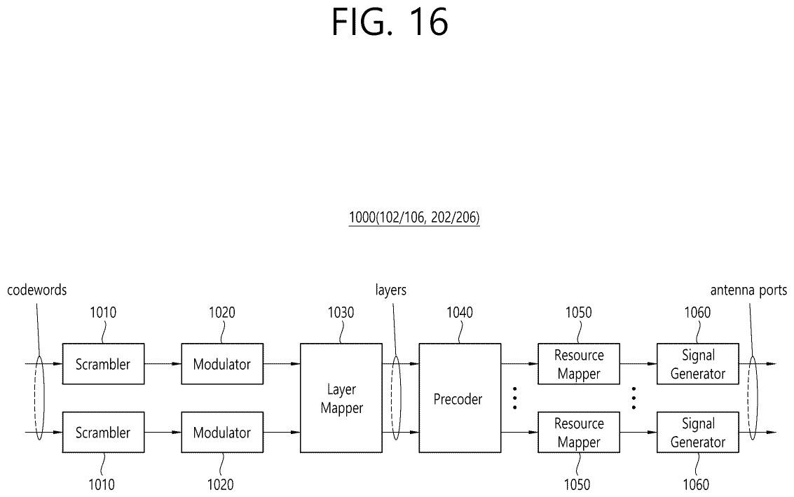

FIG. 16 shows a signal process circuit for a transmission signal, based on an embodiment of the present disclosure. The embodiment of FIG. 16 may be combined with various embodiments of the present disclosure.

Referring to FIG. 16, a signal processing circuit 1000 may include scramblers 1010, modulators 1020, a layer mapper 1030, a precoder 1040, resource mappers 1050, and signal generators 1060. An operation/function of FIG. 16 may be performed, without being limited to, the processors 102 and 202 and/or the transceivers 106 and 206 of FIG. 15. Hardware elements of FIG. 16 may be implemented by the processors 102 and 202 and/or the transceivers 106 and 206 of FIG. 15. For example, blocks 1010 to 1060 may be implemented by the processors 102 and 202 of FIG. 15. Alternatively, the blocks 1010 to 1050 may be implemented by the processors 102 and 202 of FIG. 15 and the block 1060 may be implemented by the transceivers 106 and 206 of FIG. 15.

Codewords may be converted into radio signals via the signal processing circuit 1000 of FIG. 16. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 16. For example, the wireless devices (e.g., 100 and 200 of FIG. 15) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

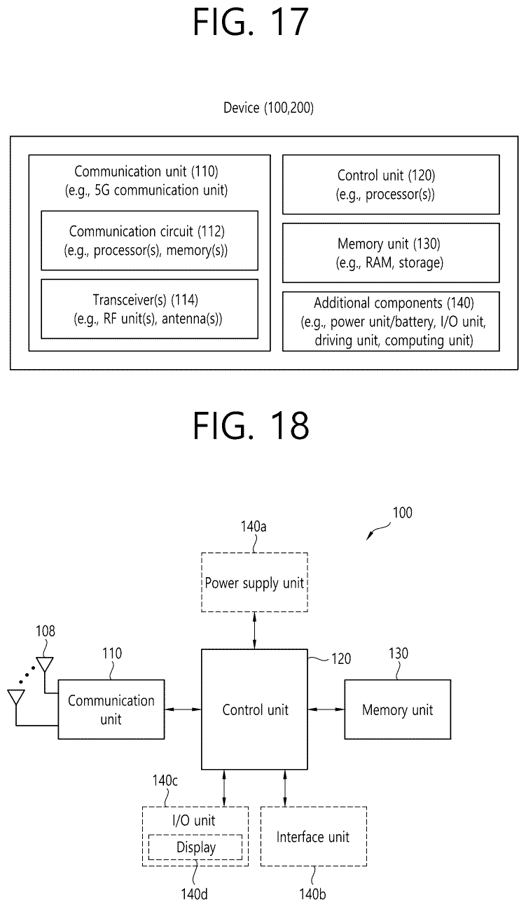

FIG. 17 shows another example of a wireless device, based on an embodiment of the present disclosure. The wireless device may be implemented in various forms according to a use-case/service (refer to FIG. 14). The embodiment of FIG. 17 may be combined with various embodiments of the present disclosure.

Referring to FIG. 17, wireless devices 100 and 200 may correspond to the wireless devices 100 and 200 of FIG. 15 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 15. For example, the transceiver(s) 114 may include the one or more transceivers 106 and 206 and/or the one or more antennas 108 and 208 of FIG. 15. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 14), the vehicles (100b-1 and 100b-2 of FIG. 14), the XR device (100c of FIG. 14), the hand-held device (100d of FIG. 14), the home appliance (100e of FIG. 14), the IoT device (100f of FIG. 14), a digital broadcast terminal, a hologram device, a public safety device, an MTC device, a medicine device, a fintech device (or a finance device), a security device, a climate/environment device, the AI server/device (400 of FIG. 14), the BSs (200 of FIG. 14), a network node, etc. The wireless device may be used in a mobile or fixed place according to a use-example/service.

In FIG. 17, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 17 will be described in detail with reference to the drawings.

FIG. 18 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT). The embodiment of FIG. 18 may be combined with various embodiments of the present disclosure.

Referring to FIG. 18, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 17, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

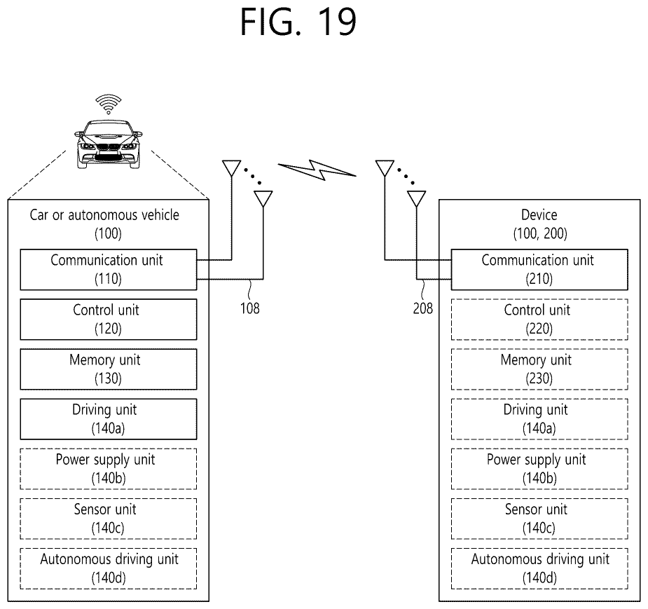

FIG. 19 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc. The embodiment of FIG. 19 may be combined with various embodiments of the present disclosure.

Referring to FIG. 19, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 17, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method for performing wireless communication by a first device, the method comprising:
obtaining configuration information related to a discontinuous reception (DRX);
triggering a beam failure recovery (BFR);
transmitting, to a second device, a BFR medium access control (MAC) control element (CE), based on the triggered BFR; and
receiving, from the second device, a MAC CE including information related to whether the BFR has succeeded,
wherein a time duration between the transmission of the BFR MAC CE and the reception of the MAC CE including information related to whether the BFR has succeeded is an active time of the first device.

2. The method of claim 1, wherein MAC CE including information related to whether the BFR has succeeded is at least one of (i) a BFR confirmation MAC CE, or (ii) a MAC CE including acknowledgement (ACK) information related to a reception of the BFR MAC CE.

3. The method of claim 1, wherein the BFR is triggered based on a number of beam failures detected within an inactive time of the first device reaching a threshold value, and
wherein a time after the BFR is triggered is the active time of the first device.

4. The method of claim 3, wherein the inactive time of the first device is changed to the active time of the first device, based on the triggered BFR.

5. The method of claim 1, further comprising:
transmitting, to the second device, information for requesting information related to a beam; and
receiving, from the second device, the information related to the beam,
wherein a time duration between a time when the information for requesting information related to the beam is transmitted and a time when a beam selection is completed based on the received information related to the beam is the active time of the first device.

6. The method of claim 5, wherein the information related to the beam includes information at least one of (i) at least one beam, (ii) a reference signal (RS) related to the at least one beam, or (iii) resource for the RS.

7. The method of claim 5, wherein a timer is started based on the transmission of the information for requesting information related to the beam, and
wherein a time duration during which the timer is running is the active time of the first device.

8. The method of claim 1, further comprising:
determining a failure of the BFR,
wherein a time after the determination related to the failure of the BFR is the active time of the first device.

9. The method of claim 8, wherein, based on the failure of the BFR being related to a first session between the first device and the second device, a second session between the first device and the second device is established at the active time.

10. The method of claim 1, further comprising:
performing a beam sweeping,
wherein a time after the beam sweeping is completed is the active time of the first device.

11. The method of claim 1, wherein the BFR is triggered based on receiving requesting information from the second device, and
wherein the requesting information is received based on at least one of control information or a MAC CE.

12. The method of claim 1, wherein a timer is started based on the reception of the requesting information from the second device, and
wherein a time duration during which the timer is running is the active time of the first device.

13. The method of claim 1, wherein a monitoring related to at least one of a physical control channel or a physical shared channel is performed at the active time of the first device.

14. A first device adapted to perform wireless communication, the first device comprising:
at least one transceiver;
at least one processor; and
at least one memory connected to the at least one processor and storing instructions that, based on being executed, cause the first device to perform operations comprising:
obtaining configuration information related to a discontinuous reception (DRX);
triggering a beam failure recovery (BFR);
transmitting, to a second device, a BFR medium access control (MAC) control element (CE), based on the triggered BFR; and
receiving, from the second device, a MAC CE including information related to whether the BFR has succeeded,
wherein a time duration between the transmission of the BFR MAC CE and the reception of the MAC CE including information related to whether the BFR has succeeded is an active time of the first device.

15.-20. (canceled)

21. The first device of claim 14, wherein MAC CE including information related to whether the BFR has succeeded is at least one of (i) a BFR confirmation MAC CE, or (ii) a MAC CE including acknowledgement (ACK) information related to a reception of the BFR MAC CE.

22. The first device of claim 14, wherein the BFR is triggered based on a number of beam failures detected within an inactive time of the first device reaching a threshold value, and
wherein a time after the BFR is triggered is the active time of the first device.

23. The first device of claim 22, wherein the inactive time of the first device is changed to the active time of the first device, based on the triggered BFR.

24. A processing device adapted to control a first device to perform wireless communication, the processing device comprising:
at least one processor; and
at least one memory connected to the at least one processor and storing instructions that, based on being executed, cause the at least one processor to perform operations comprising:
obtaining configuration information related to a discontinuous reception (DRX);
triggering a beam failure recovery (BFR);
transmitting, to a second device, a BFR medium access control (MAC) control element (CE), based on the triggered BFR; and
receiving, from the second device, a MAC CE including information related to whether the BFR has succeeded,
wherein a time duration between the transmission of the BFR MAC CE and the reception of the MAC CE including information related to whether the BFR has succeeded is an active time of the first device.

25. The processing device of claim 24, wherein MAC CE including information related to whether the BFR has succeeded is at least one of (i) a BFR confirmation MAC CE, or (ii) a MAC CE including acknowledgement (ACK) information related to a reception of the BFR MAC CE.

26. The processing device of claim 24, wherein the BFR is triggered based on a number of beam failures detected within an inactive time of the first device reaching a threshold value, and
wherein a time after the BFR is triggered is the active time of the first device.
